(19) United States
(12) Patent Application Publication
(10) Pub. No.: US 2018/0114511 A1
(43) Pub. Date: Apr. 26, 2018

(54) MUSICAL INSTRUMENT ASSISTANCE SYSTEM

(71) Applicant: Apurva Shrivastava, Duluth, GA (US)

(72) Inventor: Apurva Shrivastava, Duluth, GA (US)

(21) Appl. No.: 15/332,438

(22) Filed: Oct. 24, 2016

(51) Int. Cl. G10D 9/04

(52) U.S. Cl. CPC G10D 9/043

(57) ABSTRACT

An apparatus having two levers working in tandem with each other such that when pressing one lever, triggers the other lever which closes the hole that needs to be closed. The length and the contact point of the lever may be variable. The diameter of the large and small straps is also variable. A combination of these variables allow this invention to close any hole on any woodwind device, regardless of its location or size. Moreover, the free finger or any lever working in conjunction with this lever, may be anywhere on the woodwind instrument which may overcome the variability in the length of fingers of different artists.

### CROSS-REFERENCE TO RELATED APPLICATIONS

Not applicable.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection by the author thereof. The copyright owner has no objection to the facsimile reproduction by anyone of the patent document or patent disclosure for the purposes of referencing as patent prior art, as it appears in the Patent and Trademark Office, patent file or records, but otherwise reserves all copyright rights whatsoever.

### FIELD OF INVENTION

One or more embodiments of the invention generally relate to musical instrument assistance system. More particularly, certain embodiments of the invention relate to devices, which may be joined to musical instruments, to allow particular sounds to be played.

### BACKGROUND OF THE RELEVANT PRIOR ART

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Playing some traditional musical instruments, such as a flute, may involve covering holes of the instrument. Conventional keys holes on woodwind instruments may be of a standard size and standard lengths because conventional woodwind instruments are generally standardized as a closed end pipe. Assistance devices may generally be used in conjunction with an instrument, such as a flute, being played, to possibly help new players to learn the standardized metal flute. However, a woodwind instrument that has a hole in a non-standard place on the instrument, may not be closed by a finger. For example, an Indian bamboo flute, or Bansuri, is typically played with 6 holes covered by three fingers on each hand. The seventh hole may be located anywhere on the instrument, past the sixth hole. Moreover, flutists may attempt to be covered to the seventh hole to produce an extra note in the lowest octave or for playing glissando between two octaves. Only the pinky and the thumb are free to cover a hole. However, they are too far from the hole to cover them.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that related technology generally illustrates a statically constructed assistance device constructed to fit a standard flute. One conventional approach may include a stationary thumb support for a flute. Another conventional approach may include a device that may be statically fixed to a standardized flute for wind guidance. Furthermore, another conventional approach may include a fixed device that may close and open at least 3 key holes of a traditional, standard, metal flute. These conventional approaches may provide generally fixed devices, and the lengths may not be changed to shorten and/or extend to cover the same key holes for different length flutes and non-standard flutes.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates an exemplary embodiment of a musical instrument assistance system, in accordance with an embodiment of the present invention;

FIG. 2 illustrates an exemplary embodiment of a trigger lever device, in accordance with an embodiment of the present invention;

FIG. 3 illustrates an exemplary embodiment of a first strap device, in accordance with an embodiment of the present invention;

FIG. 4 illustrates an exemplary embodiment of a valve lifter device, in accordance with an embodiment of the present invention;

FIG. 5A and FIG. 5B illustrate various views of an exemplary embodiment of a second strap device, in accordance with an embodiment of the present invention, where FIG. 5A illustrates a top view of the exemplary embodiment of the second strap device, and FIG. 5B illustrates a bottom view thereof;

FIG. 6 illustrates an exemplary detailed view of an exemplary embodiment of a musical instrument assistance system, in accordance with an embodiment of the present invention;

FIG. 7A through FIG. 7C illustrate various views of an exemplary embodiment of a musical instrument assistance system, in accordance with an embodiment of the present invention, where FIG. 7A illustrates a left perspective view of the exemplary embodiment of the musical instrument assistance system, FIG. 7B illustrates a right perspective view thereof, and FIG. 7C illustrates an exemplary lever view thereof;

FIG. 8 illustrates an exemplary embodiment of a musical instrument assistance system generally configured in an exemplary closed position, in accordance with an embodiment of the present invention;

FIG. 9A through FIG. 9E illustrate various views of an exemplary configuration of an exemplary embodiment of a musical instrument assistance system, in accordance with an embodiment of the present invention, where FIG. 9A illustrates an exemplary rotated left perspective view thereof, FIG. 9B illustrates an exemplary rotated right perspective view thereof, FIG. 9C illustrates an exemplary further rotated left perspective view of an exemplary configuration of an exemplary embodiment of a musical instrument assistance system, FIG. 9D illustrates an exemplary valve view of the exemplary configuration of an exemplary embodiment of a musical instrument assistance system, and FIG. 9E illustrates an exemplary zoomed-in view thereof;

FIG. 10 illustrates an exemplary configuration of an exemplary embodiment of a musical instrument assistance system, generally configured in an exemplary open position, in accordance with an embodiment of the present invention;

FIG. 11A and FIG. 11B illustrate various views of an exemplary configuration of an exemplary practical application of an embodiment of a musical instrument assistance system, in accordance with an embodiment of the present invention, where FIG. 11A illustrates the exemplary embodiment of a musical instrument system generally configured in an exemplary closed position, and FIG. 11B illustrates a wide-range view thereof;

FIG. 12 illustrates a flow chart of an exemplary method of covering and opening a hole of a woodwind instrument in accordance with an embodiment of the present invention;

FIG. 13A through FIG. 13C illustrate an exemplary configuration of an exemplary embodiment of a musical instrument assistance system, in accordance with an embodiment of the present invention, where FIG. 13A illustrates a left perspective view of the exemplary configuration of the exemplary embodiment musical instrument assistance system, FIG. 13B illustrates a bottom perspective view thereof, and FIG. 13C illustrates a top perspective view thereof;

FIG. 14 illustrates an exemplary configuration of an exemplary embodiment of a valve lifter device, in accordance with an embodiment of the present invention;

FIG. 15 illustrates an exemplary embodiment of a musical instrument assistance system, in accordance with an embodiment of the present invention; and

FIG. 16 illustrates an exemplary configuration of an exemplary embodiment of a trigger lever device, in accordance with an embodiment of the present invention.

Unless otherwise indicated illustrations in the figures are not necessarily drawn to scale.

### DETAILED DESCRIPTION OF SOME EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

All words of approximation as used in the present disclosure and claims should be construed to mean “approximate,” rather than “perfect,” and may accordingly be employed as a meaningful modifier to any other word, specified parameter, quantity, quality, or concept. Words of approximation, include, yet are not limited to terms such as “substantial”, “nearly”, “almost”, “about”, “generally”, “largely”, “essentially”, “closely approximate”, etc.

As will be established in some detail below, it is well settle law, as early as 1939, that words of approximation are not indefinite in the claims even when such limits are not defined or specified in the specification.

For example, see Ex parte Mallory, 52 USPQ 297, 297 (Pat. Off. Bd. App. 1941) where the court said “The examiner has held that most of the claims are inaccurate because apparently the laminar film will not be entirely eliminated. The claims specify that the film is “substantially” eliminated and for the intended purpose, it is believed that the slight portion of the film which may remain is negligible. We are of the view, therefore, that the claims may be regarded as sufficiently accurate.”

Note that claims need only “reasonably apprise those skilled in the art” as to their scope to satisfy the definiteness requirement. See Energy Absorption Sys., Inc. v. Roadway Safety Servs., Inc., Civ. App. 96-1264, slip op. at 10 (Fed. Cir. Jul. 3, 1997) (unpublished) Hybridtech v. Monoclonal Antibodies, Inc., 802 F.2d 1367, 1385, 231 USPQ 81, 94 (Fed. Cir. 1986), cert. denied, 480 U.S. 947 (1987). In addition, the use of modifiers in the claim, like “generally” and “substantial,” does not by itself render the claims indefinite. See Seattle Box Co. v. Industrial Crating & Packing, Inc., 731 F.2d 818, 828-29, 221 USPQ 568, 575-76 (Fed. Cir. 1984).

Moreover, the ordinary and customary meaning of terms like “substantially” includes “reasonably close to: nearly, almost, about”, connoting a term of approximation. See In re Frye, Appeal No. 2009-006013, 94 USPQ2d 1072, 1077, 2010 WL 889747 (B.P.A.I. 2010) Depending on its usage, the word “substantially” can denote either language of approximation or language of magnitude. Deering Precision Instruments, L.L.C. v. Vector Distribution Sys., Inc., 347 F.3d 1314, 1323 (Fed. Cir. 2003) (recognizing the “dual ordinary meaning of th[e] term [”substantially“] as connoting a term of approximation or a term of magnitude”). Here, when referring to the “substantially halfway” limitation, the Specification uses the word “approximately” as a substitute for the word “substantially” (Fact 4). (Fact 4). The ordinary meaning of “substantially halfway” is thus reasonably close to or nearly at the midpoint between the forwardmost point of the upper or outsole and the rearwardmost point of the upper or outsole.

Similarly, the term ‘substantially’ is well recognize in case law to have the dual ordinary meaning of connoting a term of approximation or a term of magnitude. See Dana Corp. v. American Axle & Manufacturing, Inc., Civ. App. 04-1116, 2004 U.S. App. LEXIS 18265, *13-14 (Fed. Cir. Aug. 27, 2004) (unpublished). The term “substantially” is commonly used by claim drafters to indicate approximation. See Cordis Corp. v. Medtronic AVE Inc., 339 F.3d 1352, 1360 (Fed. Cir. 2003) (“The patents do not set out any numerical standard by which to determine whether the thickness of the wall surface is ‘substantially uniform.’ The term ‘substantially,’ as used in this context, denotes approximation. Thus, the walls must be of largely or approximately uniform thickness.”); see also Deering Precision Instruments, LLC v. Vector Distribution Sys., Inc., 347 F.3d 1314, 1322 (Fed. Cir. 2003); Epcon Gas Sys., Inc. v. Bauer Compressors, Inc., 279 F.3d 1022, 1031 (Fed. Cir. 2002). We find that the term “substantially” was used in just such a manner in the claims of the patents-in-suit: “substantially uniform wall thickness” denotes a wall thickness with approximate uniformity.

It should also be noted that such words of approximation as contemplated in the foregoing clearly limits the scope of claims such as saying ‘generally parallel’ such that the adverb ‘generally’ does not broaden the meaning of parallel. Accordingly, it is well settled that such words of approximation as contemplated in the foregoing (e.g., like the phrase ‘generally parallel’) envisions some amount of deviation from perfection (e.g., not exactly parallel), and that such words of approximation as contemplated in the foregoing are descriptive terms commonly used in patent claims to avoid a strict numerical boundary to the specified parameter. To the extent that the plain language of the claims relying on such words of approximation as contemplated in the foregoing are clear and uncontradicted by anything in the written description herein or the figures thereof, it is improper to rely upon the present written description, the figures, or the prosecution history to add limitations to any of the claim of the present invention with respect to such words of approximation as contemplated in the foregoing. That is, under such circumstances, relying on the written description and prosecution history to reject the ordinary and customary meanings of the words themselves is impermissible. See, for example, Liquid Dynamics Corp. v. Vaughan Co., 355 F.3d 1361, 69 USPQ2d 1595, 1600-01 (Fed. Cir. 2004). The plain language of phrase 2 requires a “substantial helical flow.” The term “substantial” is a meaningful modifier implying “approximate,” rather than “perfect.” In Cordis Corp. v. Medtronic AVE, Inc., 339 F.3d 1352, 1361 (Fed. Cir. 2003), the district court imposed a precise numeric constraint on the term “substantially uniform thickness.” We noted that the proper interpretation of this term was “of largely or approximately uniform thickness” unless something in the prosecution history imposed the “clear and unmistakable disclaimer” needed for narrowing beyond this simple-language interpretation. Id. In Anchor Wall Systems v. Rockwood Retaining Walls, Inc., 340 F.3d 1298, 1311 (Fed. Cir. 2003)” Id. at 1311. Similarly, the plain language of Claim 1 requires neither a perfectly helical flow nor a flow that returns precisely to the center after one rotation (a limitation that arises only as a logical consequence of requiring a perfectly helical flow).

The reader should appreciate that case law generally recognizes a dual ordinary meaning of such words of approximation, as contemplated in the foregoing, as connoting a term of approximation or a term of magnitude; e.g., see Deering Precision Instruments, L.L.C. v. Vector Distrib. Sys., Inc., 347 F.3d 1314, 68 USPQ2d 1716, 1721 (Fed. Cir. 2003), cert. denied, 124 S. Ct. 1426 (2004) where the court was asked to construe the meaning of the term “substantially” in a patent claim. Also see Epcon, 279 F.3d at 1031 (“The phrase ‘substantially constant’ denotes language of approximation, while the phrase ‘substantially below’ signifies language of magnitude, i.e., not insubstantial.”). Also, see, e.g., Epcon Gas Sys., Inc. v. Bauer Compressors, Inc., 279 F.3d 1022 (Fed. Cir. 2002) (construing the terms “substantially constant” and “substantially below”); Zodiac Pool Care, Inc. v. Hoffinger Indus., Inc., 206 F.3d 1408 (Fed. Cir. 2000) (construing the term “substantially inward”); York Prods., Inc. v. Cent. Tractor Farm & Family Ctr., 99 F.3d 1568 (Fed. Cir. 1996) (construing the term “substantially the entire height thereof”); Tex. Instruments Inc. v. Cypress Semiconductor Corp., 90 F.3d 1558 (Fed. Cir. 1996) (construing the term “substantially in the common plane”). In conducting their analysis, the court instructed to begin with the ordinary meaning of the claim terms to one of ordinary skill in the art. Prima Tek, 318 F.3d at 1148. Reference to dictionaries and our cases indicates that the term “substantially” has numerous ordinary meanings. As the district court stated, “substantially” can mean “significantly” or “considerably.” The term “substantially” can also mean “largely” or “essentially.” Webster's New 20th Century Dictionary 1817 (1983).

Words of approximation, as contemplated in the foregoing, may also be used in phrases establishing approximate ranges or limits, where the end points are inclusive and approximate, not perfect; e.g., see AK Steel Corp. v. Sollac, 344 F.3d 1234, 68 USPQ2d 1280, 1285 (Fed. Cir. 2003) where it where the court said [W]e conclude that the ordinary meaning of the phrase “up to about 10%” includes the “about 10%” endpoint. As pointed out by AK Steel, when an object of the preposition “up to” is nonnumeric, the most natural meaning is to exclude the object (e.g., painting the wall up to the door). On the other hand, as pointed out by Sollac, when the object is a numerical limit, the normal meaning is to include that upper numerical limit (e.g., counting up to ten, seating capacity for up to seven passengers). Because we have here a numerical limit—“about 10%”—the ordinary meaning is that that endpoint is included.

In the present specification and claims, a goal of employment of such words of approximation, as contemplated in the foregoing, is to avoid a strict numerical boundary to the modified specified parameter, as sanctioned by Pall Corp. v. Micron Separations, Inc., 66 F.3d 1211, 1217, 36 USPQ2d 1225, 1229 (Fed. Cir. 1995) where it states “It is well established that when the term “substantially” serves reasonably to describe the subject matter so that its scope would be understood by persons in the field of the invention, and to distinguish the claimed subject matter from the prior art, it is not indefinite.” Likewise see Verve LLC v. Crane Cams Inc., 311 F.3d 1116, 65 USPQ2d 1051, 1054 (Fed. Cir. 2002). Expressions such as “substantially” are used in patent documents when warranted by the nature of the invention, in order to accommodate the minor variations that may be appropriate to secure the invention. Such usage may well satisfy the charge to “particularly point out and distinctly claim” the invention, 35 U.S.C. § 112, and indeed may be necessary in order to provide the inventor with the benefit of his invention. In Andrew Corp. v. Gabriel Elecs. Inc., 847 F.2d 819, 821-22, 6 USPQ2d 2010, 2013 (Fed. Cir. 1988) the court explained that usages such as “substantially equal” and “closely approximate” may serve to describe the invention with precision appropriate to the technology and without intruding on the prior art. The court again explained in Ecolab Inc. v. Envirochem, Inc., 264 F.3d 1358, 1367, 60 USPQ2d 1173, 1179 (Fed. Cir. 2001) that “like the term ‘about,’ the term ‘substantially’ is a descriptive term commonly used in patent claims to ‘avoid a strict numerical boundary to the specified parameter, see Ecolab Inc. v. Envirochem Inc., 264 F.3d 1358, 60 USPQ2d 1173, 1179 (Fed. Cir. 2001) where the court found that the use of the term “substantially” to modify the term “uniform” does not render this phrase so unclear such that there is no means by which to ascertain the claim scope.

Similarly, other courts have noted that like the term “about,” the term “substantially” is a descriptive term commonly used in patent claims to “avoid a strict numerical boundary to the specified parameter.”; e.g., see Pall Corp. v. Micron Seps., 66 F.3d 1211, 1217, 36 USPQ2d 1225, 1229 (Fed. Cir. 1995); see, e.g., Andrew Corp. v. Gabriel Elecs. Inc., 847 F.2d 819, 821-22, 6 USPQ2d 2010, 2013 (Fed. Cir. 1988) (noting that terms such as “approach each other,” “close to,” “substantially equal,” and “closely approximate” are ubiquitously used in patent claims and that such usages, when serving reasonably to describe the claimed subject matter to those of skill in the field of the invention, and to distinguish the claimed subject matter from the prior art, have been accepted in patent examination and upheld by the courts). In this case, “substantially” avoids the strict 100% nonuniformity boundary.

Indeed, the foregoing sanctioning of such words of approximation, as contemplated in the foregoing, has been established as early as 1939, see Ex parte Mallory, 52 USPQ 297, 297 (Pat. Off. Bd. App. 1941) where, for example, the court said “the claims specify that the film is “substantially” eliminated and for the intended purpose, it is believed that the slight portion of the film which may remain is negligible. We are of the view, therefore, that the claims may be regarded as sufficiently accurate.” Similarly, In re Hutchison, 104 F.2d 829, 42 USPQ 90, 93 (C.C.P.A. 1939) the court said “It is realized that “substantial distance” is a relative and somewhat indefinite term, or phrase, but terms and phrases of this character are not uncommon in patents in cases where, according to the art involved, the meaning can be determined with reasonable clearness.”

Hence, for at least the forgoing reason, Applicants submit that it is improper for any examiner to hold as indefinite any claims of the present patent that employ any words of approximation.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will be described in detail below with reference to embodiments thereof as illustrated in the accompanying drawings.

References to a “device,” an “apparatus,” a “system,” etc., in the preamble of a claim should be construed broadly to mean “any structure meeting the claim terms” exempt for any specific structure(s)/type(s) that has/(have) been explicitly disavowed or excluded or admitted/implied as prior art in the present specification or incapable of enabling an object/aspect/goal of the invention. Furthermore, where the present specification discloses an object, aspect, function, goal, result, or advantage of the invention that a specific prior art structure and/or method step is similarly capable of performing yet in a very different way, the present invention disclosure is intended to and shall also implicitly include and cover additional corresponding alternative embodiments that are otherwise identical to that explicitly disclosed except that they exclude such prior art structure(s)/step(s), and shall accordingly be deemed as providing sufficient disclosure to support a corresponding negative limitation in a claim claiming such alternative embodiment(s), which exclude such very different prior art structure(s)/step(s) way(s).

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” “some embodiments,” “embodiments of the invention,” etc., may indicate that the embodiment(s) of the invention so described may include a particular feature, structure, or characteristic, but not every possible embodiment of the invention necessarily includes the particular feature, structure, or characteristic. Further, repeated use of the phrase “in one embodiment,” or “in an exemplary embodiment,” “an embodiment,” do not necessarily refer to the same embodiment, although they may. Moreover, any use of phrases like “embodiments” in connection with “the invention” are never meant to characterize that all embodiments of the invention must include the particular feature, structure, or characteristic, and should instead be understood to mean “at least some embodiments of the invention” includes the stated particular feature, structure, or characteristic.

References to “user”, or any similar term, as used herein, may mean a human or non-human user thereof. Moreover, “user”, or any similar term, as used herein, unless expressly stipulated otherwise, is contemplated to mean users at any stage of the usage process, to include, without limitation, direct user(s), intermediate user(s), indirect user(s), and end user(s). The meaning of “user”, or any similar term, as used herein, should not be otherwise inferred or induced by any pattern(s) of description, embodiments, examples, or referenced prior-art that may (or may not) be provided in the present patent.

References to “end user”, or any similar term, as used herein, is generally intended to mean late stage user(s) as opposed to early stage user(s). Hence, it is contemplated that there may be a multiplicity of different types of “end user” near the end stage of the usage process. Where applicable, especially with respect to distribution channels of embodiments of the invention comprising consumed retail products/services thereof (as opposed to sellers/vendors or Original Equipment Manufacturers), examples of an “end user” may include, without limitation, a “consumer”, “buyer”, “customer”, “purchaser”, “shopper”, “enjoyer”, “viewer”, or individual person or non-human thing benefiting in any way, directly or indirectly, from use of. or interaction, with some aspect of the present invention.

In some situations, some embodiments of the present invention may provide beneficial usage to more than one stage or type of usage in the foregoing usage process. In such cases where multiple embodiments targeting various stages of the usage process are described, references to “end user”, or any similar term, as used therein, are generally intended to not include the user that is the furthest removed, in the foregoing usage process, from the final user therein of an embodiment of the present invention.

Where applicable, especially with respect to retail distribution channels of embodiments of the invention, intermediate user(s) may include, without limitation, any individual person or non-human thing benefiting in any way, directly or indirectly, from use of, or interaction with, some aspect of the present invention with respect to selling, vending, Original Equipment Manufacturing, marketing, merchandising, distributing, service providing, and the like thereof.

References to “person”, “individual”, “human”, “a party”, “animal”, “creature”, or any similar term, as used herein, even if the context or particular embodiment implies living user, maker, or participant, it should be understood that such characterizations are sole by way of example, and not limitation, in that it is contemplated that any such usage, making, or participation by a living entity in connection with making, using, and/or participating, in any way, with embodiments of the present invention may be substituted by such similar performed by a suitably configured non-living entity, to include, without limitation, automated machines, robots, humanoids, computational systems, information processing systems, artificially intelligent systems, and the like. It is further contemplated that those skilled in the art will readily recognize the practical situations where such living makers, users, and/or participants with embodiments of the present invention may be in whole, or in part, replaced with such non-living makers, users, and/or participants with embodiments of the present invention. Likewise, when those skilled in the art identify such practical situations where such living makers, users, and/or participants with embodiments of the present invention may be in whole, or in part, replaced with such non-living makers, it will be readily apparent in light of the teachings of the present invention how to adapt the described embodiments to be suitable for such non-living makers, users, and/or participants with embodiments of the present invention. Thus, the invention is thus to also cover all such modifications, equivalents, and alternatives falling within the spirit and scope of such adaptations and modifications, at least in part, for such non-living entities.

Headings provided herein are for convenience and are not to be taken as limiting the disclosure in any way.

The enumerated listing of items does not imply that any or all of the items are mutually exclusive, unless expressly specified otherwise.

It is understood that the use of specific component, device and/or parameter names are for example only and not meant to imply any limitations on the invention. The invention may thus be implemented with different nomenclature/terminology utilized to describe the mechanisms/units/structures/components/devices/parameters herein, without limitation. Each term utilized herein is to be given its broadest interpretation given the context in which that term is utilized.

Terminology. The following paragraphs provide definitions and/or context for terms found in this disclosure (including the appended claims):

“Comprising.” This term is open-ended. As used in the appended claims, this term does not foreclose additional structure or steps. Consider a claim that recites: “A memory controller comprising a system cache . . . . ” Such a claim does not foreclose the memory controller from including additional components (e.g., a memory channel unit, a switch).

“Configured To.” Various units, circuits, or other components may be described or claimed as “configured to” perform a task or tasks. In such contexts, “configured to” or “operable for” is used to connote structure by indicating that the mechanisms/units/circuits/components include structure (e.g., circuitry and/or mechanisms) that performs the task or tasks during operation. As such, the mechanisms/unit/circuit/component can be said to be configured to (or be operable) for perform(ing) the task even when the specified mechanisms/unit/circuit/component is not currently operational (e.g., is not on). The mechanisms/units/circuits/components used with the “configured to” or “operable for” language include hardware—for example, mechanisms, structures, electronics, circuits, memory storing program instructions executable to implement the operation, etc. Reciting that a mechanism/unit/circuit/component is “configured to” or “operable for” perform(ing) one or more tasks is expressly intended not to invoke 35 U.S.C. sctn.112, sixth paragraph, for that mechanism/unit/circuit/component. “Configured to” may also include adapting a manufacturing process to fabricate devices or components that are adapted to implement or perform one or more tasks.

“Based On.” As used herein, this term is used to describe one or more factors that affect a determination. This term does not foreclose additional factors that may affect a determination. That is, a determination may be solely based on those factors or based, at least in part, on those factors. Consider the phrase “determine A based on B.” While B may be a factor that affects the determination of A, such a phrase does not foreclose the determination of A from also being based on C. In other instances, A may be determined based solely on B.

The terms “a”, “an” and “the” mean “one or more”, unless expressly specified otherwise.

Unless otherwise indicated, all numbers expressing conditions, concentrations, dimensions, and so forth used in the specification and claims are to be understood as being modified in all instances by the term “about.” Accordingly, unless indicated to the contrary, the numerical parameters set forth in the following specification and attached claims are approximations that may vary depending at least upon a specific analytical technique.

The term “comprising,” which is synonymous with “including,” “containing,” or “characterized by” is inclusive or open-ended and does not exclude additional, unrecited elements or method steps. “Comprising” is a term of art used in claim language which means that the named claim elements are essential, but other claim elements may be added and still form a construct within the scope of the claim.

As used herein, the phase “consisting of” excludes any element, step, or ingredient not specified in the claim. When the phrase “consists of” (or variations thereof) appears in a clause of the body of a claim, rather than immediately following the preamble, it limits only the element set forth in that clause; other elements are not excluded from the claim as a whole. As used herein, the phase “consisting essentially of” and “consisting of” limits the scope of a claim to the specified elements or method steps, plus those that do not materially affect the basis and novel characteristic(s) of the claimed subject matter (see Norian Corp. v Stryker Corp., 363 F.3d 1321, 1331-32, 70 USPQ2d 1508, Fed. Cir. 2004). Moreover, for any claim of the present invention which claims an embodiment “consisting essentially of” or “consisting of” a certain set of elements of any herein described embodiment it shall be understood as obvious by those skilled in the art that the present invention also covers all possible varying scope variants of any described embodiment(s) that are each exclusively (i.e., “consisting essentially of”) functional subsets or functional combination thereof such that each of these plurality of exclusive varying scope variants each consists essentially of any functional subset(s) and/or functional combination(s) of any set of elements of any described embodiment(s) to the exclusion of any others not set forth therein. That is, it is contemplated that it will be obvious to those skilled how to create a multiplicity of alternate embodiments of the present invention that simply consisting essentially of a certain functional combination of elements of any described embodiment(s) to the exclusion of any others not set forth therein, and the invention thus covers all such exclusive embodiments as if they were each described herein.

With respect to the terms “comprising,” “consisting of,” and “consisting essentially of,” where one of these three terms is used herein, the presently disclosed and claimed subject matter may include the use of either of the other two terms. Thus in some embodiments not otherwise explicitly recited, any instance of “comprising” may be replaced by “consisting of” or, alternatively, by “consisting essentially of”, and thus, for the purposes of claim support and construction for “consisting of” format claims, such replacements operate to create yet other alternative embodiments “consisting essentially of” only the elements recited in the original “comprising” embodiment to the exclusion of all other elements.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary a variety of optional components are described to illustrate the wide variety of possible embodiments of the present invention.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

As will be described in some detail below, in an embodiment of the present invention, an exemplary musical instrument assistance system may be, without limitation, removably and adjustably configured to generally join substantially any size woodwind musical instrument with generally standardized and non-standardized key holes, to assist in playing the woodwind musical instrument. Embodiments of the present invention may allow a user to use a free finger in conjunction with the embodiments of the present invention, to facilitate the closing of musical instrument key holes.

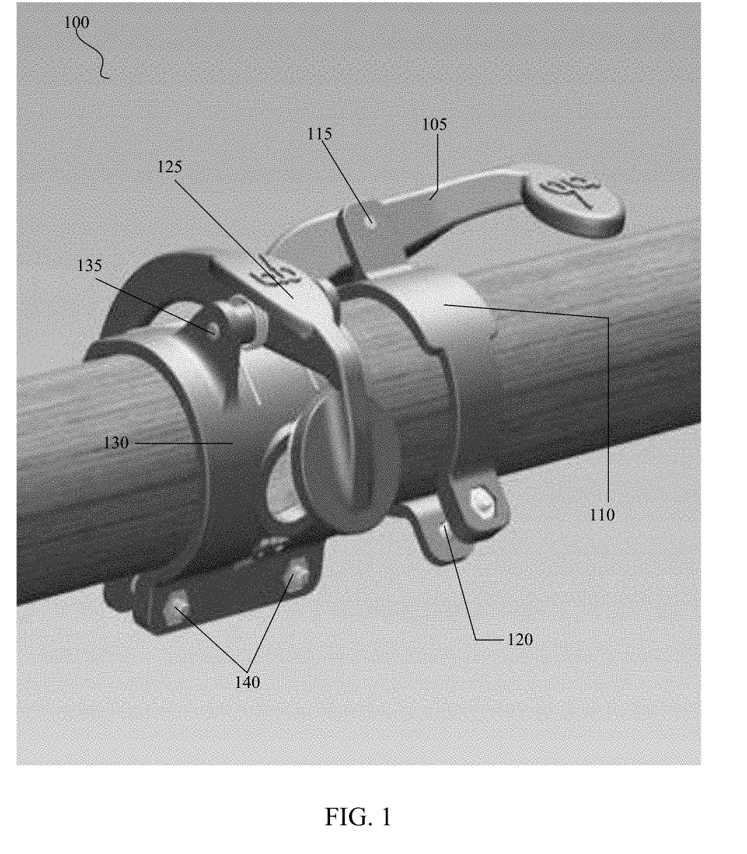

FIG. 1 illustrates an exemplary embodiment of an exemplary, without limitation, musical instrument assistance system 100, in accordance with an embodiment of the present invention. In the present embodiment, the exemplary musical instrument assistance system 100 may comprise, without limitation, an exemplary trigger lever device 105 that may be, without limitation, configured to be movably joined to an exemplary first strap device 110, by an exemplary, without limitation, first joining mechanism 115. In the present embodiment, the exemplary musical instrument assistance system 100 may comprise, without limitation, the exemplary first strap device 110, wherein the exemplary first strap device 110 may be, without limitation, configured to be removably and adjustably joined to substantially any size woodwind musical instrument, by an exemplary, without limitation, second joining mechanism 120. In the present embodiment, the exemplary musical instrument assistance system 100 may comprise, without limitation, the exemplary trigger lever device 105, wherein the exemplary trigger lever device 105 may be, without limitation, further configured to be in contact with a valve lifter device 125. In the present embodiment, the exemplary musical instrument assistance system 100 may comprise, without limitation, the exemplary valve lifter device 125, wherein the exemplary valve lifter device 125 may be, without limitation, configured to be movably joined to a second strap device 130, by an exemplary, without limitation, third joining mechanism 135. In the present embodiment, the exemplary valve lever device 125, may also be, without limitation, configured to generally interact with a portion of substantially any size woodwind musical instrument. In the present embodiment, the exemplary musical instrument assistance system 100 may comprise, without limitation, the exemplary second strap device 130, wherein the exemplary second strap device 130 may be, without limitation, configured to be removably and adjustably joined to substantially any size woodwind musical instrument, by an exemplary, without limitation, fourth joining mechanism 140, so that a range of operation of a of user, with respect to the woodwind musical instrument, may be extended.

It is contemplated that in another exemplary embodiment, of the present invention, an exemplary musical instrument assistance system 100 may comprise, without limitation, any combination of a multiplicity of an exemplary trigger lever device 105, a multiplicity of an exemplary first strap device 110, a multiplicity of an exemplary valve lifter device 125, and a multiplicity of an exemplary second strap device 130, that may be, without limitation, configured to generally be joined together by a multiplicity of an exemplary, without limitation, first joining mechanism 115 and a multiplicity of an exemplary, without limitation, third joining mechanism 135, wherein, the any combination may further be configured to be removably and adjustably joined to substantially any size woodwind musical instrument, by a multiplicity of an exemplary, without limitation, second joining mechanism 120 and a multiplicity of an exemplary, without limitation, fourth joining mechanism 140. For example, without limitation, in an exemplary embodiment of the present invention, a musical instrument assistance system, may comprise, a first grouping of generally removable and adjustable devices, as described above and as illustrated in FIG. 1, and further comprise, a second, or more groupings of generally removable and adjustable devices, generally configured, without limitation, such that an exemplary, without limitation, valve lifter device in one group may be configured to come into contact with and trigger an exemplary, without limitation, trigger lever device of another group, and thus generally linking groups of devices to further extend a range of operation of an exemplary, without limitation, embodiment of the musical instrument assistance system 100.

It is further contemplated that in another exemplary embodiment, without limitation, a multiplicity of exemplary, without limitation, musical instrument assistance system 100 may be removably and adjustably joined to a same, substantially any size, woodwind musical instrument, wherein each exemplary, without limitation, musical instrument assistance device 100 of the multiplicity may be configured to operate independently from each other. For example, without limitation, a first musical instrument assistance system 100 may be operated to cause an exemplary, without limitation, first valve lifter device 125 to generally interact with a first portion of an exemplary, without limitation, woodwind musical instrument, and an exemplary, without limitation, second or more musical instrument assistance system 100 may be operated to cause an exemplary, without limitation, second valve lifter device 125 to generally interact with a second portion of the exemplary, without limitation, woodwind musical instrument, wherein the first portion and second portion may be different locations on a single exemplary, without limitation, woodwind instrument.

In at least one alternative embodiment of the present invention, a musical instrument assistance system may comprise, fewer than all of an exemplary, without limitation, trigger lever device 105, an exemplary, without limitation, first strap device 110, an exemplary, without limitation, valve lifter device 125, an exemplary, without limitation, second strap device 130, an exemplary, without limitation, first joining mechanism 115, an exemplary, without limitation, second joining mechanism 120, an exemplary, without limitation, third joining mechanism 135, and an exemplary, without limitation, fourth joining mechanism 140. For example, without limitation, in an alternative embodiment of the present invention, an exemplary musical instrument assistance system may comprise only a valve lifter device 125, statically joined to a musical instrument. In another alternative embodiment, an exemplary instrument assistance system may comprise, without limitation, any combination of fewer than all of an exemplary, without limitation, trigger lever device 105, an exemplary, without limitation, first strap device 110, an exemplary, without limitation, valve lifter device 115, an exemplary, without limitation, second strap device 130, an exemplary, without limitation, first joining mechanism 115, an exemplary, without limitation, second joining mechanism 120, an exemplary, without limitation, third joining mechanism 135, and an exemplary, without limitation, fourth joining mechanism 140. For example, without limitation, an alternative embodiment of the present invention, may comprise an exemplary trigger lever device 125, that may be configured in a fixed or moveable operating position, and further may be configured to generally join an exemplary, without limitation, second strap device 130, by an exemplary, without limitation, third joining mechanism 135, wherein, the second strap device 130 may be configured to be removably and adjustably joined to an exemplary woodwind instrument.

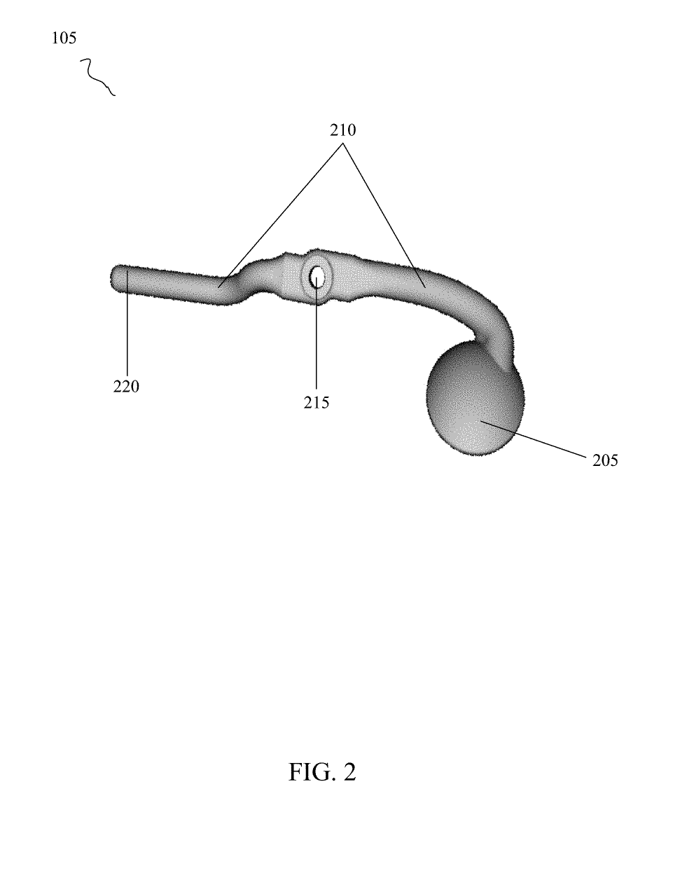

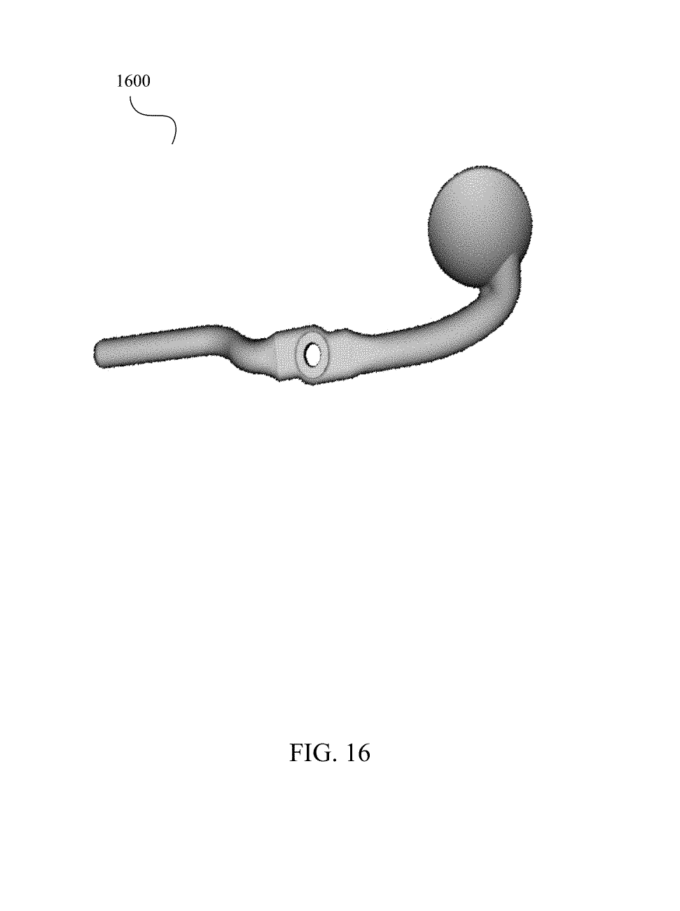

Referring now to FIG. 2, an exemplary, without limitation, trigger lever device 105, in accordance with an embodiment of the present invention is illustrated. In the present embodiment, exemplary, without limitation, trigger lever device 105 may be configured to comprise an exemplary, without limitation, trigger lever device head portion 205, wherein the trigger lever device head portion 205 may be fixed to an exemplary, without limitation, trigger lever device stem portion 210, wherein the trigger lever device stem portion 210 may comprise an exemplary, without limitation, generally centralized trigger lever device hole 215, and an exemplary, without limitation, trigger lever device contact end 220. In the present embodiment, the exemplary, without limitation, trigger lever device 105 may be configured, as a single, ergonomically shaped structure, wherein the trigger lever device head portion 205, may be easily and readily accessible by, without limitation, a digit of a user. In the present embodiment of the present invention, exemplary, without limitation, trigger lever device 105 may be comprised of a thermoplastic polymer, such as, without limitation, Acrylonitrile Butadiene-Styrene (ABS), Poly lactic acid (PLA), thermoplastic polyester, Cycolac™, Magnum™, polycarbonate materials, any known thermoplastic polymer reinforced with carbon fiber, AeroGel Technologies™ materials, and pliable metal alloys Aluminum, PLA, ABS, PETG, Gold, Silver, Steel, Resin, Polyamide, Alumide, Titanium, Brass, Bronze, Wood, Rubber, Copper, ABS plastic, PLA, polyamide (nylon), glass filled polyamide, stereo lithography materials (epoxy resins), silver, titanium, steel, wax, photopolymers and polycarbonate. In the present embodiment of the present invention, exemplary, without limitation, trigger lever device 105 may be of a fixed length. In the present embodiment of the present invention exemplary, without limitation, trigger lever device 105 may be ergonomically shaped and easily accessible by, without limitation, a digit of a user's left hand. In another embodiment of the present invention a trigger device stem portion may be, without limitation, of variable length. Now with reference to FIG. 16, in another embodiment of the present invention, an exemplary, without limitation, trigger device 1600, may be ergonomically shaped so that it may be easily accessible by, without limitation, a digit of a user's right hand. In another of the present invention, a trigger lever device contact end may be, without limitation, configured to comprise a joining mechanism, such as, without limitation, a hook or curved shape to enable contact maintenance, an adhesive, a screw and/or screw hole mechanism, a slot, a protrusion that may be slotted, fasteners, and a nut and bolt mechanism. In some alternative embodiments of the present invention, a trigger lever device head portion may be adjustably joined to a trigger lever device stem portion, by a joining mechanism. In some alternative embodiments of the present invention, a trigger lever device head portion may rotate with respect to a trigger lever device stem portion. In some alternative embodiments of the present invention, a trigger lever device head portion may extend in length away from a trigger lever device stem portion. In some alternative embodiments trigger lever device head portion may be, without limitation, interchangeable with other trigger lever device head portions of a multiplicity of sizes. In some alternative embodiments of the present invention, a trigger lever device head portion may be ridged as to create a higher friction contact. In an alternative embodiment of the present invention, exemplary, without limitation, trigger lever device 105 may be comprised of substantially any known material that may be pliable and may generally maintain a formed shape.

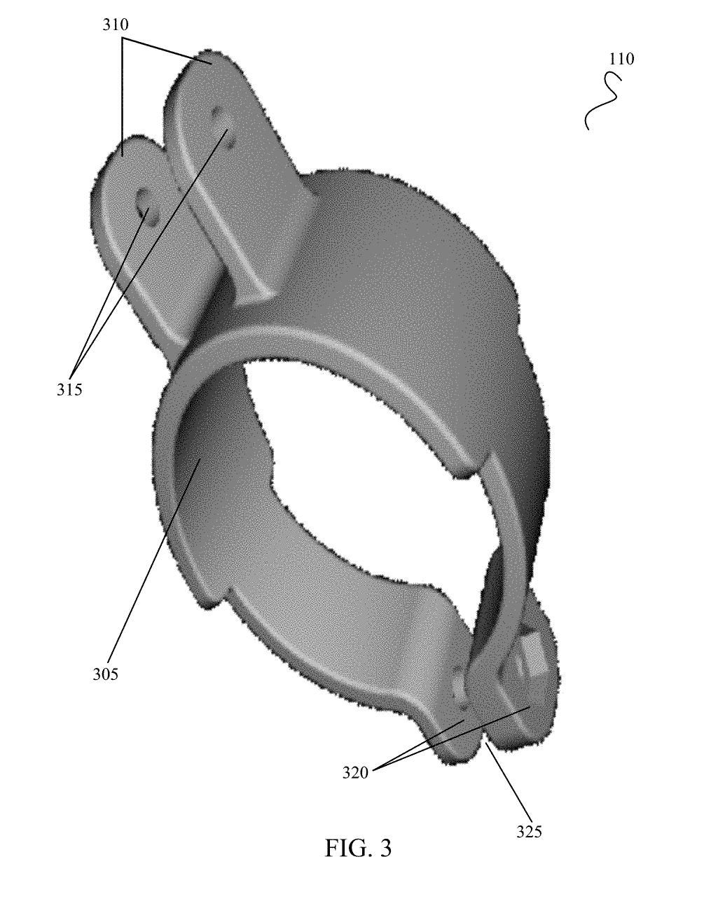

FIG. 3 illustrates an exemplary embodiment of a first strap device, in accordance with an embodiment of the present invention. In the present embodiment, exemplary, without limitation, first strap device 110 may be configured to comprise an exemplary, without limitation, a first strap device body portion 305. In the present embodiment the exemplary, without limitation, first strap device body portion 305 may be configured to be of a generally circular shape and further may comprise an exemplary, without limitation, first strap device protruding support portion 310, wherein the first strap device protruding support portion may comprise more than one generally vertical protruding portions that generally protrude in parallel and in close proximity to each other. Furthermore, the protruding portions may be approximately perpendicular to a surface of a first strap device body portion. In the present embodiment, exemplary, without limitation, protruding support portion 310, may be configured to comprise an exemplary, without limitation, first strap device swivel support portion 315, wherein the first strap device swivel support portion may comprise more than one hole. In the present embodiment, exemplary, without limitation, first strap device 305 may be configured to comprise an exemplary, without limitation, first strap device adjusting portion 320, wherein the first strap device adjusting portion 320 may be configured to comprise more than one protruding portions such that a gap 325 may be formed between the first strap device adjusting portion. In the present embodiment, first strap device 110 may be comprise of, without limitation, a thermoplastic polymer, such as, without limitation, Acrylonitrile Butadiene-Styrene (ABS), Poly lactic acid (PLA), thermoplastic polyester, Cycolac™, Magnum™, polycarbonate materials, any known thermoplastic polymer reinforced with carbon fiber, AeroGel Technologies™ materials, and pliable metal alloys. Aluminum, PLA, ABS, PETG, Gold, Silver, Steel, Resin, Polyamide, Alumide, Titanium, Brass, Bronze, Wood, Rubber, Copper, ABS plastic, PLA, polyamide (nylon), glass filled polyamide, stereo lithography materials (epoxy resins), silver, titanium, steel, wax, photopolymers and polycarbonate. In the present embodiment, first strap device may be flexible such that an exemplary, without limitation, first strap device adjusting portion 320 may be adjusted so that gap 325 may be variable up to and including a maximum distance, wherein the maximum distance is slightly less than a circumference of an exemplary, without limitation, first strap body portion. The small strap can be stretched to a range of 0.5 inch. In the present embodiment an exemplary, without limitation, first strap device adjusting portion 320 may be configured to comprise holes and indentations for a screw and nut joining mechanism. The strap can be glued on using any adhesive that sticks to the woodwind instrument and then may be tied with a thread including but not limited to a fishing thread, or a cable. In an alternative embodiment of the present invention, a protruding support section may be configured to comprise at least one protruding portion. In an alternative embodiment the at least one protruding section may be configured to comprise a first strap device swivel support portion, wherein the first strap device swivel portion may comprise a plurality of holes aligned horizontally, vertically and/or radially, to allow a plurality of support positions to be configured. In an alternative embodiment a first strap device swivel support portion may comprise a recession slot. In an alternative embodiment an inner surface of a first strap body portion may be coated with an adhesive. In another alternative embodiment an inner surface of a first strap body portion may be comprised of an adhesive material that allows for repeated installation of a strap on and off a multiplicity of instruments, for a multiplicity of times.

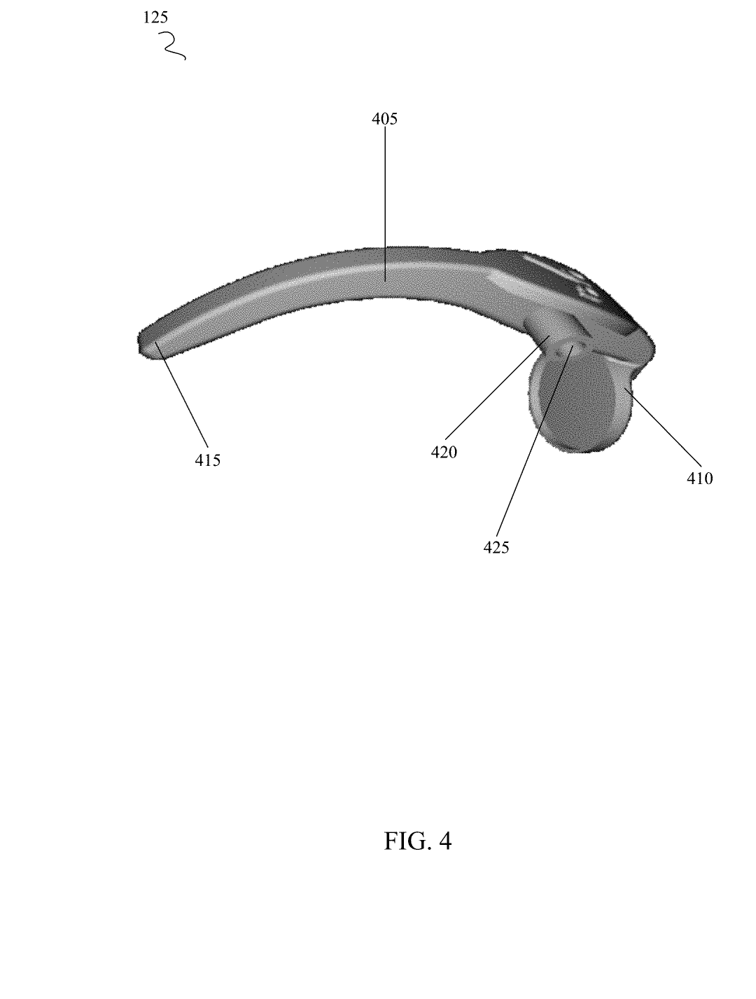

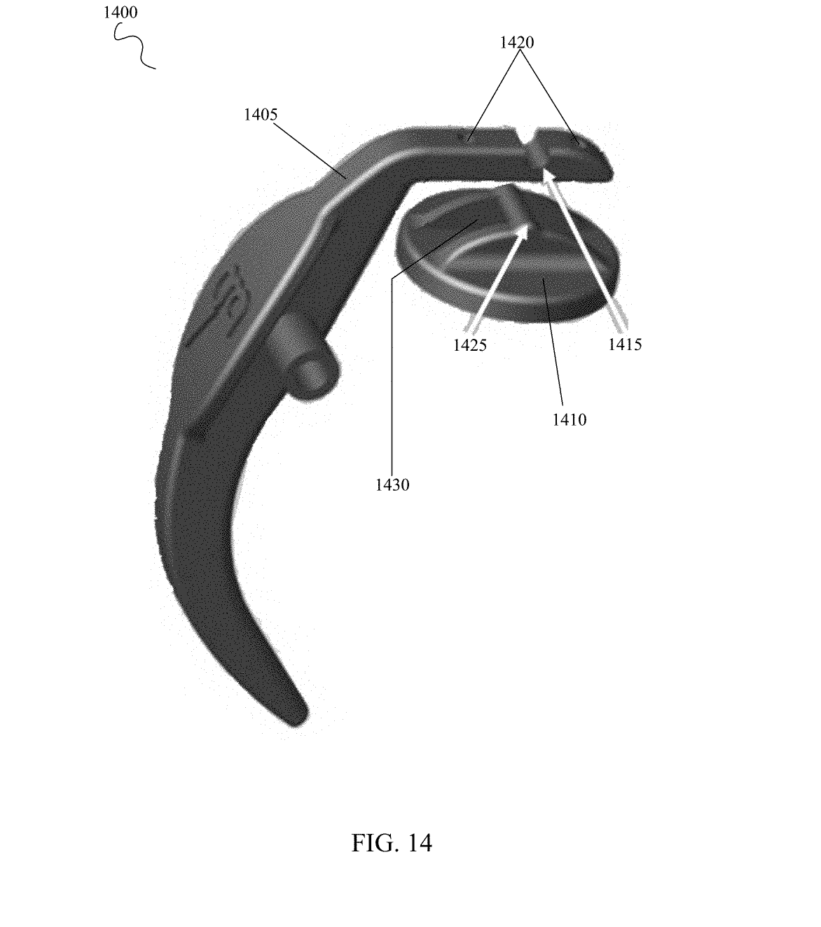

FIG. 4 illustrates an exemplary embodiment of an exemplary, without limitation, valve lifter device 125, in accordance with an embodiment of the present invention. In a present embodiment of the present invention, an exemplary, without limitation, valve lifter device may be configured to comprise an exemplary, without limitation, valve lifter device stem portion 405. The valve lifter device stem portion may be generally curved in shape and of fixed length as to better align with an exemplary, without limitation, substantially any size woodwind musical instrument. In the present embodiment, valve lifter stem portion 405, may be configured to comprise an exemplary, without limitation, valve lifter device cover 410. In the present embodiment the valve lifter device cover 410 may be fixed to the valve lifter device stem portion 405 at an approximate perpendicular angle. Furthermore, pad lifter device cover 410 may be configured to comprise a recession on one surface and also may be configured to be of a generally circular shape. In the present invention exemplar, without limitation, valve lifter device stem portion 405 may further be configured to comprise an exemplary, without limitation, valve lifter device connection end 415. Exemplary, without limitation, valve lifter device stem portion 405 may also be configured to comprise an exemplar, without limitation a valve lifter device shaft 420 that provides an exemplary valve lifter device swivel hole 425. In the present embodiment exemplary, without limitation, valve lifter device 125 may comprise the valve lifter device shaft positioned at a middle location of on the exemplary, without limitation, valve lifter device stem 405. In the present embodiment, exemplary, valve lifter device 125, may be comprise of, without limitation, a singular structure that may be comprised of a thermoplastic polymer, such as, without limitation, Acrylonitrile Butadiene-Styrene (ABS), Poly lactic acid (PLA), thermoplastic polyester, Cycolac™, Magnum™, polycarbonate materials, any known thermoplastic polymer reinforced with carbon fiber, AeroGel Technologies™ materials, and pliable metal alloys Aluminum, PLA, ABS, PETG, Gold, Silver, Steel, Resin, Polyamide, Alumide, Titanium, Brass, Bronze, Wood, Rubber, Copper, ABS plastic, PLA, polyamide (nylon), glass filled polyamide, stereo lithography materials (epoxy resins), silver, titanium, steel, wax, photopolymers and polycarbonate. In another embodiment of the present invention, a valve lifter device connection end may be, without limitation, configured to comprise a joining mechanism, such as, without limitation, a hook or curved shape to enable contact maintenance, an adhesive, a screw and/or screw hole mechanism, a slot, a protrusion that may be slotted, fasteners, and a nut and bolt mechanism. A multiplicity of suitable of lever end configurations are contemplated that may provide permanent or semi-permanent attachment depending upon the needs of the particular application, which may include, but not limited to, straight, and bending inwards from the left. L shaped from outside in. In another embodiment an exemplary, without limitation, valve lifter device may be variable in length. In an alternative embodiment an exemplary, without limitation, valve lifter device stem portion may be variable in length, wherein, the valve lifter device stem portion may be extended or shorten in a circular direction. In an alternative embodiment, an exemplary, without limitation, valve lifter device stem portion may be extended or shorten in a lateral direction. Now referring to FIG. 14, in another embodiment of the present invention, illustrated exemplary, without limitation, valve lifter device 1400, may be configure to comprise an exemplary, without limitation, valve lifter device stem portion 1405 removably and adjustably joined to an exemplary, without limitation, valve lifter device cove 1410. Furthermore, exemplary, without limitation, valve lifter device swivel recession 1415 and an exemplary, without limitation, valve lifter device position adjuster 1420, located at an end the valve lever device stem portion 1405, wherein valve lifter device position adjuster 1420 may comprise screw holes. The exemplary, without limitation, valve lifter device cover 1410, may be configured to comprise an exemplary, without limitation, valve lifter device cover swivel support 1425 on a surface opposite to a recession surface of the valve lifter device cover. Furthermore, the valve lifter device cover swivel support 1425 may be configured to create an exemplary valve lifter device cover support gap 1430. The exemplary, without limitation, valve lifter device cover 1410 may be slid on to the valve lifter device stem portion 1405 so that valve lifter device cover swivel support 1425 may align and fit into valve lifter device swivel recession 1415. The valve lifter device cover 1410 may then be configured to swivel and pivot to further allow alignment with an instrument to be interacted with, wherein that interaction may be to cover a hole. In another embodiment, the valve lifter device position support may be utilized using screws to fix the valve lifter device cover to a particular angled position. In another exemplary embodiment, without limitation, a valve lifter device cover may comprise more than one generally vertical protrusions from a surface opposite of a recession surface, wherein the protrusions may have holes and a swivel support bar may be slid through the holes and onto the valve lifter device swivel recession to removably and adjustably join the valve lifter device cover to a valve lifter device stem portion. In an alternative embodiment a valve lifter device stem portion may be of variable length. In an alternative embodiment, the more than one protrusions may have a plurality of vertically aligned holes for joining at a plurality of heights. In an alternate embodiment the more than one protrusions may have a plurality of horizontally aligned holes for joining at a plurality of distances. In an alternative embodiment, a valve lifter device cover may be configured to comprise at least one vertical protrusion opposite to a recession surface, wherein the protrusion may comprise a plurality of vertically and/or horizontally aligned holes for joining at a plurality of heights and/or distances. In an alternative embodiment, the at least one protrusion may comprise holes arranges radially for joining at a plurality of position. In an alternative embodiment a valve lifter device swivel recession may be a hole rather than a recession.

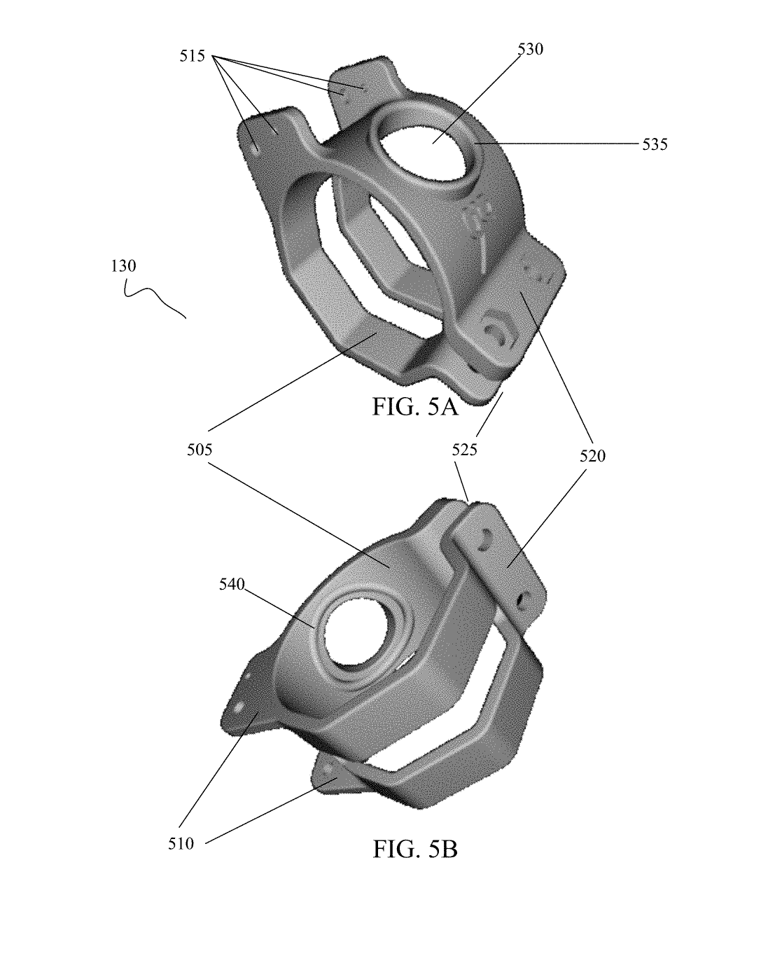

FIG. 5A and FIG. 5B illustrate various views of an exemplary embodiment of a second strap device 130, in accordance with an embodiment of the present invention, where FIG. 5A illustrates a top view of the exemplary embodiment of the second strap device 120, and FIG. 5B illustrates a bottom view thereof In the present embodiment of the present invention, exemplary, without limitation, second strap device 130 comprises an exemplary, without limitation, second strap device body portion 505. The second strap device body portion 505, may be of a generally circular in shape in structure, and further may comprise an exemplary, without limitation, second strap device protruding support portion 510, wherein the second strap device protruding support portion may comprise more than one protruding portions that generally protrude in parallel and in close proximity to each other. In the present embodiment, exemplary, without limitation, second strap device protruding support portion 510, may be configured to comprise an exemplary, without limitation, second strap device swivel support portion 515, wherein the second strap device swivel support portion may comprise more than one hole. In the present embodiment, exemplary, without limitation, second strap device 505 may be configured to comprise an exemplary, without limitation, second strap device adjusting portion 520, wherein the second strap device adjusting portion 520 may be configured to comprise more than one protruding portions such that a gap 525 may be formed between the first strap device adjusting portion. In the present embodiment, exemplary, without limitation, second strap device body portion 505, may be configured to comprise an exemplary, without limitation, keyhole opening 530, in a surface of the second strap device body portion 505. Furthermore, second strap device body portion 505, may be configured to comprise an exemplary, without limitation, keyhole opening support 535, wherein the keyhole opening support 535 is located on an outer surface of the second strap device body portion 505. The exemplary, without limitation, keyhole opening support 535 generally protrudes vertically from the outer surface, and further, generally circumscribes the key hole opening 530. In the present embodiment, exemplary, without limitation, second strap device 505, may be configured to comprise an exemplary, without limitation, insulation device recession portion. The insulation device recession portion may be located on an inner surface of second strap device body portion 505, wherein the insulation device recession portion may generally circumscribe the keyhole opening 530, and may be configured of sufficient depth to at least partially house, an exemplary, without limitation, insulation device 540. In the present embodiment an exemplary, without limitation, insulation device, may be generally circular in shape and comprised: of rubber, plastics polymers, ceramics, metal alloys, or any suitable material that may provide a desired sound and air insulation upon operation of some embodiments of the present invention. In the present embodiment second strap device 130 may be comprise of, without limitation, a thermoplastic polymer, such as, without limitation, Acrylonitrile Butadiene-Styrene (ABS), Poly lactic acid (PLA), thermoplastic polyester, Cycolac™, Magnum™, polycarbonate materials, any known thermoplastic polymer reinforced with carbon fiber, AeroGel Technologies™ materials, and pliable metal alloys. Buna-N (Nitrile), Silicone, Viton® (Fluorocarbon Type A), EPDM (Ethylene Propylene), Chemraz®/Kalrez®/Simriz® (Perfluoroelastomer), Neoprene® (Chloroprene), Fluorosilicone, Urethane, Teflon Encapsulated, Teflon® In the present embodiment, the second strap device may be flexible such that an exemplary, without limitation, second strap device adjusting portion 520 may be adjusted so that gap 525 may be variable up to and including a maximum distance, wherein the maximum distance is slightly less than a circumference of an exemplary, without limitation, second strap body portion. The small strap may be stretched to a range of 0.5 inch. In the present embodiment an exemplary, without limitation, second strap device adjusting portion 520 may be configured to comprise holes and indentations for a screw and nut joining mechanism. The strap may be glued on using any adhesive that sticks to the woodwind instrument, and may be tied with a thread including a fishing thread, or a steel cable. In an alternative embodiment of the present invention, a protruding support section may be configured to comprise at least one protruding portion. In an alternative embodiment the at least one protruding section may be configured to comprise a second strap device swivel support portion, wherein the second strap device swivel support portion may comprise a plurality of holes aligned horizontally, vertically and/or radially, to allow a plurality of support positions to be configured. In an alternative embodiment a second strap device swivel support portion may comprise a recession slot. In an alternative embodiment an inner surface of a second strap body portion may be coated with an adhesive. In another alternative embodiment an inner surface of a second strap body portion may be comprised of an adhesive material that allows for repeated installation of a strap on and off a multiplicity of instruments, for a multiplicity of times.

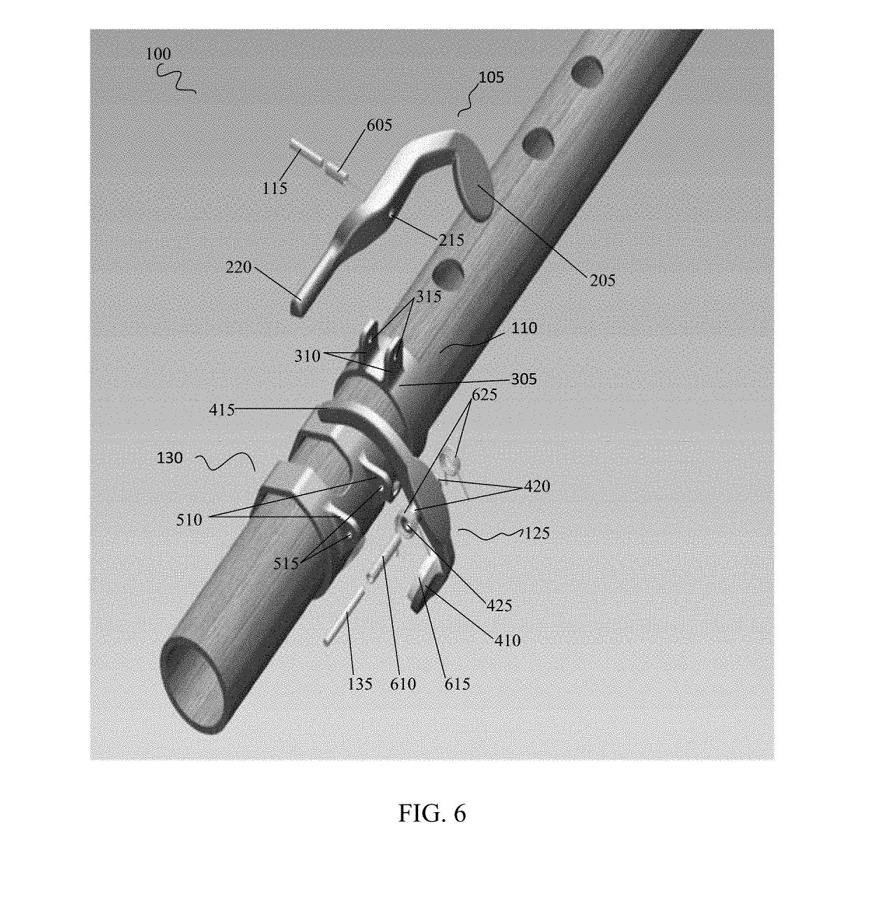

Referring now to FIG. 6, as well as FIG. 1 through FIG. 5, collectively. FIG. 6 illustrates an exemplary detailed view of an exemplary embodiment of a musical instrument assistance system 100, in accordance with an embodiment of the present invention. In an embodiment of the present invention an exemplary, without limitation, assembly of a musical instrument assistance system may comprise, without limitation, firstly preparing an exemplary trigger lever device 105, wherein an exemplary, without limitation, first sleeve device 605, may be inserted into an exemplary, without limitation, trigger lever device hole 215. The first sleeve device may be hollow in shape and may further be comprised of a suitable material that decrease a friction coefficient, of an exemplary, without limitation, first joining mechanism 115. The Sleeve provides ability for the Dowel Pin to move freely, without much friction. It can be eliminated if other materials, like aluminum, steel etc. are used for the levers. The sleeve can be made of and hard material that will not bend under will allow the dowel pin to move without much friction like Brass, copper, steel, aluminum, Titanium, rubber Secondly, the trigger lever device 105, with inserted sleeve 605, may be positioned between protruding portions of an exemplary, without limitation, first strap device protruding support portion 310 of an exemplary, without limitation, first strap device 110, wherein the trigger lever device may be aligned with an exemplary, without limitation, first strap device swivel support portion 315. The aligning of the trigger lever device 105 and the first strap device swivel support portion 315, may comprise aligning the trigger lever device hole 215 with an exemplary, without limitation, more than one hole of the first strap swivel support portion 315. Thirdly, an exemplary, without limitation, first joining mechanism 115, may be inserted through the aligned holes, wherein the first joining mechanism 115 may, by example, without limitation, comprise a bushing, and thus allowing the trigger lever device 105 to pivot up and down while being generally joined to the first strap device 110. Next, first strap device 110, with movably joined trigger lever 105 may be removably and adjustably slid onto substantially any size woodwind musical instrument to a desired location, for example, and without limitation, to a location so that a user's finger may generally contact an exemplary, without limitation, trigger lever device head portion 205. Then, an exemplary, without limitation, first strap device body portion 305, of the first strap device 110 may be temporarily tightened and thus temporarily fixed to the instrument by an exemplary, without limitation, first strap device adjusting portion 320 in conjunction with an exemplary, without limitation, second joining mechanism 120, wherein the second joining mechanism 120 may be, without limitation, a screw and nut mechanism. Next, an exemplary, without limitation, second sleeve device 610, may be inserted into an exemplary, without limitation, valve lifter device swivel hole 425, of valve lifter device 125. The second sleeve device may be hollow in shape and may further be comprised of a suitable material that decrease a friction coefficient, of an exemplary, without limitation, third joining mechanism 135. The Sleeve provides ability for the dowel pin to move freely, without much friction. It may be eliminated if other materials, such as, but not limited to aluminum or steel are used for the levers. The sleeve may be made of any hard material that will not bend under will allow the dowel pin to move without much friction such as, but not limited to, brass, copper, steel, aluminum, titanium, rubber. Then, an exemplary, without limitation, motion aiding device 625, may be inserted onto, an exemplary, without limitation, valve lifter device shaft 420. The valve lifter device 125, with inserted sleeve 610, may be positioned between protruding portions of an exemplary, without limitation, second strap device protruding support portion 510 of an exemplary, without limitation, second strap device 130, wherein the valve lifter device 125 may be aligned with an exemplary, without limitation, second strap device swivel support portion 515. The aligning of the valve lifter device 125 and the second strap device swivel support portion 515, may comprise aligning the valve lifter device swivel hole 425 with an exemplary, without limitation, more than one hole of the second strap device swivel support portion 515. Next, an exemplary, without limitation, third joining mechanism 135, may be inserted through the aligned holes, wherein, third joining mechanism 135 may, by example, without limitation, comprise a bushing, and thus allowing the valve lifter device 125 to pivot up and down while being generally joined to the second strap device 130. Next, an exemplary, without limitation, insulation device 540, may be inserted into an exemplary, insulation device recession slot of the second strap device 130, so that an air-tight seal may be formed around a keyhole. Then, second strap device 130, with movably joined valve lifter device 125 may be removably and adjustably slid onto substantially any size woodwind musical instrument to a desired location, for example, and without limitation, to a location so that an exemplary, without limitation, valve lifter device connection end 415 may generally come into contact with an exemplary, without limitation, trigger lever device contact end 220, wherein valve lifter device connection end 415 may be position over top of trigger lever device contact end 220 so that, without limitation, as trigger lever device contact end 220 pivots upward, as a result of trigger lever head portion 205 pivoting downward, general contact may be made on a bottom surface of the valve lifter device connection end 415, and thus causing the valve lifter device connection end 415 to pivot upward, wherein valve lifter device cover 410 may then pivot downward. Furthermore, the location of the second strap device 130 may also be a location so that an exemplary, without limitation, keyhole opening 530, of the second strap device 130, may be aligned to a keyhole of the substantially any size woodwind instrument so that as valve lifter device cover 410 may pivot downward, a keyhole can be covered. Next, an exemplary, without limitation, second strap device body portion 505, of the second strap device 130, may be temporarily tightened and thus temporarily fixed to the instrument by an exemplary, without limitation, second strap device adjusting portion 520 in conjunction with an exemplary, without limitation, fourth joining mechanism 140, wherein the fourth joining mechanism 140 may be, without limitation, a screw and nut mechanism.

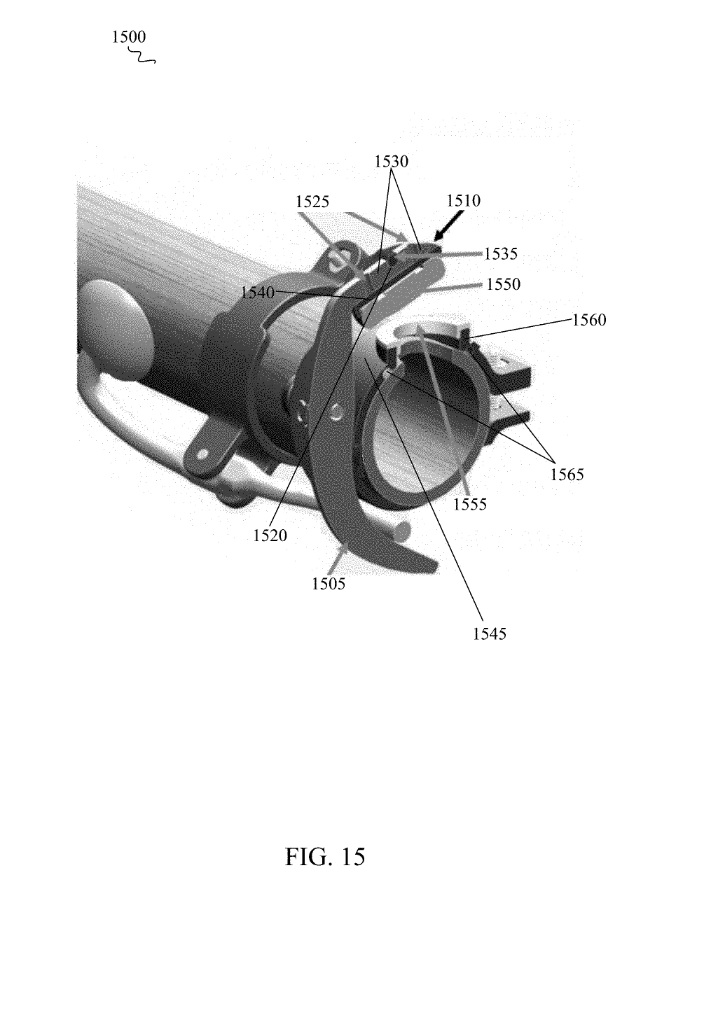

In the present embodiment of the present invention, one portion of the motion aiding device may be operably coupled to the second strap device protruding support portion 510 and another portion of the motion aiding device may be operably coupled to the valve lifter device 125, wherein the motion aiding device may apply force to the valve lifter device allowing the valve lifter device 125 to pivot. Furthermore, by example, and without limitation, motion aiding device may comprise at least one spring. In the present embodiment a second sleeve device 620 may be larger than the first sleeve device 605. In the present embodiment of the present invention a second strap device 130 may be larger than a first strap device 110. In the present embodiment the third joining mechanism 135 may be larger than the first joining mechanism 115. Furthermore, in the present embodiment of the present invention, an exemplary, without limitation, pad 615, may be fixed to a surface of the valve lifter device head portion 410 The pad is used to cover the hole of the chimney in the valve lever. It may be made of any material that does not allow air leakage. It also may be able to contour itself around the chimney, depending upon the angle of the chimney, which in turn depends upon the diameter of the flute. In another embodiment of the present invention, trigger lever device contact end and valve lifter device connection end may be configured to be fixed together by a joining mechanism, wherein the joining mechanism may be, without limitation, an adhesive, nails or screws, any suitable fasteners, or by structural reconfigurations. Now referring to FIG. 15, in another embodiment of the present invention, illustrated exemplary, without limitation, a musical instrument assistance system 1500 may be configured to further comprise an exemplary, without limitation, valve lifter device shaft 1505 removably and adjustably joined to an exemplary, without limitation, valve lifter device cover 1510. Furthermore, musical instrument assistance system 1500 may comprise an exemplary, without limitation, valve lifter device swivel recession 1520 and an exemplary, without limitation, valve lifter device position adjuster 1525, located at an exemplary, valve lever device shaft end 1530, wherein valve lifter device position adjuster 1525 may comprise screw holes. The exemplary, without limitation, valve lifter device cover 1510, may further be configured to comprise an exemplary, without limitation, valve lifter device cover swivel support 1535 on a surface opposite to an exemplary, without limitation, recession surface 1540 of the valve lifter device cover, wherein the recession surface 1540, may comprise a pad 1550, fixed to the valve lifter device cover, 1510 by, for example, without limitation an adhesive. Furthermore, the valve lifter device cover swivel support 1535 may be configured to create an exemplary valve lifter device cover support gap, wherein valve lifter device cover 1510 may be slid on to the valve lifter device shaft end 1530. so that valve lifter device cover swivel support 1535 may align and fit into valve lifter device swivel recession 1525. The valve lifter device cover 1510 may then be configured to swivel and pivot to further allow alignment with an instrument to be interacted with, wherein that interaction may be to contour automatically to the angle of a hole when covering a hole. In the present embodiment an exemplary, without limitation, strap device 1545 may comprise, without limitation an exemplary, without limitation, keyhole opening support fitting 1555, wherein the fitting may be generally circular and also may be removably joined to an, exemplary, without limitation, keyhole opening support 1560, to better provide an air-tight closure of a keyhole. The strap device 1545, may also be configured to comprise an exemplary, without limitation, insulation device recession portion 1565. The insulation device recession portion 1565 may be located on an inner surface of strap device 1545, wherein the insulation device recession portion may generally circumscribe a keyhole opening, and may be configured of sufficient depth to at least partially house, an exemplary, without limitation, insulation device. In the present embodiment an exemplary, without limitation, insulation device, may be generally circular in shape and comprised: of rubber, plastics polymers, ceramics, metal alloys, or any suitable material that may help provide a desired sound and air insulation upon fitting strap 1545 around a keyhole opening of substantially, any size woodwind musical instrument such as Buna-N (Nitrile), Silicone, Viton® (Fluorocarbon Type A), EPDM (Ethylene Propylene), Chemraz®/Kalrez®/Simriz® (Perfluoroelastomer), Neoprene® (Chloroprene), Fluorosilicone, Urethane, Teflon Encapsulated, Teflon®

In an alternative embodiment of the present invention, an aligning of a trigger lever device and a first strap device swivel support portion, may comprise aligning a trigger lever device hole with at least one hole of the first strap device swivel support portion. In another alternative embodiment, an aligning of a trigger lever device and a first strap device swivel support portion, may comprise aligning a trigger lever device hole with at least one hole, of a plurality of holes, of the first strap swivel support portion, wherein first strap device swivel support portion may comprise a plurality of holes aligned horizontally, vertically and/or radially, to allow a plurality of support positions to be configured. In an alternative embodiment, second joining mechanism may comprise an adhesive material that lines an inner surface of a first strap device body portion. In an alternative embodiment, second joining mechanism may be a first strap device body portion, wherein the material of the first strap device body portion may comprise a particular tensile strength and elasticity such that the first strap device body portion may be stretched when a suitable external force is applied but stays fixed in an enclosed shape when resting, for example, without limitation, clips made of spring metal.

In an alternative embodiment of the present invention, an aligning of a valve lifter device and a second strap device swivel support portion, may comprise aligning a valve lifter device swivel hole with at least one hole of the second strap device swivel support portion. In another alternative embodiment, an aligning of a valve lifter device and a second strap device swivel support portion, may comprise aligning a valve lifter device swivel hole with at least one hole, of a plurality of holes, of the second strap swivel support portion, wherein the second strap device swivel support portion may comprise a plurality of holes aligned horizontally, vertically and/or radially, to allow a plurality of support positions to be configured. In an alternative embodiment, fourth joining mechanism may comprise an adhesive material that lines an inner surface of a second strap device body portion. In an alternative embodiment, fourth joining mechanism may be a second strap device body portion, wherein the material of the second strap device body portion may comprise a particular tensile strength and elasticity such that the first strap device body portion may be stretched when a suitable external force is applied but stays fixed in an enclosed shape when resting, for example, without limitation, clips made of spring metal. The strap may be glued on using any adhesive that sticks to the woodwind instrument. It may also be tied with a thread including a fishing thread, or a steel cable.

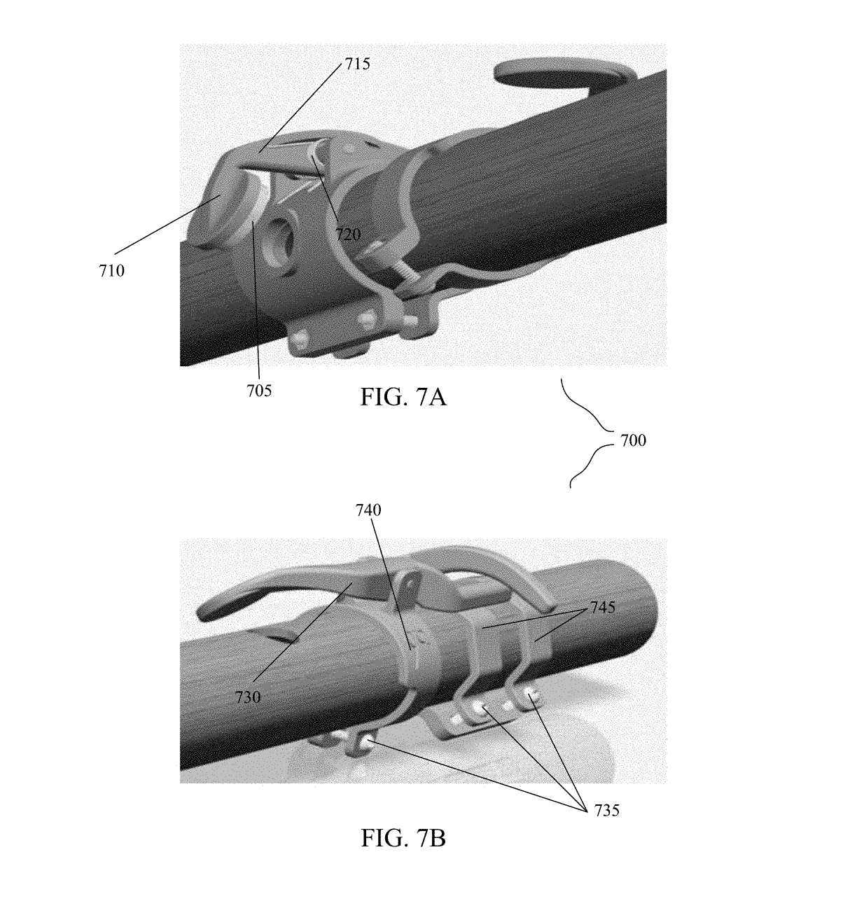

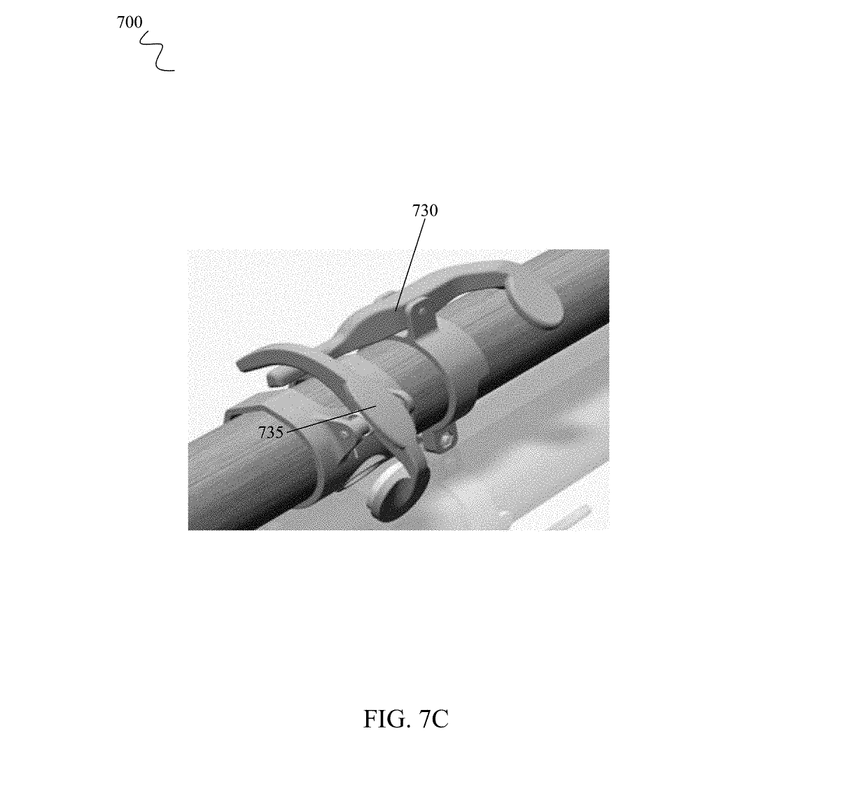

FIG. 7A through FIG. 7C illustrate various views of an exemplary embodiment of a musical instrument assistance system 700, in accordance with an embodiment of the present invention; FIG. 7A illustrates a left perspective view of the exemplary, without limitation, musical instrument assistance system 700 generally configured to be removably and adjustably joined to substantially any size woodwind musical instrument. In the present embodiment, exemplary, without limitation, musical instrument assistance device may be configured in an exemplary, without limitation, open position. Furthermore, exemplary, without limitation, musical instrument assistance device may comprise an exemplary, without limitation, pad 705 generally fixed to an exemplary, without limitation, valve lifter device cover 710, generally fixed to an exemplary, without limitation, valve lifter device cover 710. In the present embodiment, the valve lifter device cover may be fixed to an exemplary, without limitation, valve lifter device stem portion 715. Furthermore, in the present embodiment, the musical instrument assistance device may comprise an exemplary, without limitation, motion aiding device 720, wherein the motion aiding device may be configured in an exemplary, without limitation, relaxed position, generally coinciding with the valve lifter device cover 710 generally being configured in an exemplary, without limitation, raised position. In accordance with the present embodiment, FIG. 7B illustrates a right perspective view thereof, wherein, an exemplary, without limitation, trigger lever device 730 may be configured in an exemplary, without limitation, resting position. Referring back briefly to FIG. 7A in conjunction with FIG. 7B, in the present embodiment, musical instrument assistance device 700 may be generally configured to be fixedly, adjustably, and removably, joined to substantially any size woodwind musical instrument, by an exemplary, without limitation, strap joining portion 735, wherein the strap joining portion may comprise an exemplary, without limitation, nut and screw joining mechanism, that may be generally tightened, loosen and taken apart, to generally allow a first strap body portion 740, and a second strap body portion 745 of the musical instrument assistance device to generally be fixed to substantially any size woodwind instrument, then generally be adjusted on the substantially any size woodwind instrument, then generally be removed from the substantially any size woodwind instrument. In another embodiment an exemplary, without limitation, nut and screw joining mechanism may comprise screws that may be of a plurality of lengths, for example, and without limitation, sufficiently long screws, wherein, an exemplary, first and second strap body portions may be fixedly, adjustably, and removably joined to an exemplary, without limitation, relatively large size woodwind musical instrument. In an alternative embodiment, a nut and screw joining mechanism may comprise screws that are curved in shape. In another alternative embodiment, exemplary, without limitation, strap body portions may be variable in length so as to further generally be fixedly, adjustably, and removably, joined to substantially any size woodwind musical instrument. In an alternative embodiment of the present invention, a strap joining mechanism may comprise for example, without limitation, strap body portions themselves, wherein, the straps body portions may be configured of, for example, and without limitation, a sufficient elasticity and tensility coefficient ratio such that, without limitation, the strap body portions may be stretch to generally fit around and naturally/automatically compress to substantial any size circumference of substantially any size woodwind musical instrument. In yet another alternative embodiment of the present invention, an exemplary, without limitation, first and second strap joining mechanism may comprise for example, without limitation, an adhesive material that may for example, without limitation, coat an inner surface the first and second straps. In yet another alternative embodiment, exemplary, without limitation, first and second body strap portion may be variable in length, wherein the body portions may be expanded or shortened in a generally circular direction. Furthermore, FIG. 7C illustrates an exemplary lever view, without limitation, of the exemplary, without limitation, musical instrument assistance system 700 in accordance with the present embodiment of the present invention, wherein an exemplary, without limitation, valve lifter device 735, may be configured to be of an exemplary, without limitation, curved shape, such that, without limitation, contact may be essentially maintained with trigger lever device 730 while trigger lever device 730, may be configured in an exemplary, without limitation, resting position. In an another embodiment in accordance with the present invention an exemplary, without limitation, valve lifter device and an exemplary, without limitation, trigger lever device, may be, for example, and without limitation, configured as a single structural device. In another embodiment a valve lifter device may comprise an exemplary, without limitation hole, slot, or indentation, on one end, wherein a trigger lever device may be inserted. In another embodiment, an exemplary, without limitation, valve lifter device and an exemplary, without limitation, trigger lever device may be, for example, and without limitation temporarily or generally permanently fixed to each other, by an exemplary, without limitation, lever joining mechanism, wherein the exemplary, without limitation, lever joining mechanism may be, for example, and without limitation, a screw and nut mechanism, an adhesive material or substance, a loop and hook mechanism, such as, and without limitation, Velcro™, a bushing device, a nail, a fastener device, string/rope, or substantially any other thread based material, wax, epoxy substances, a structural design, or any combination thereof.

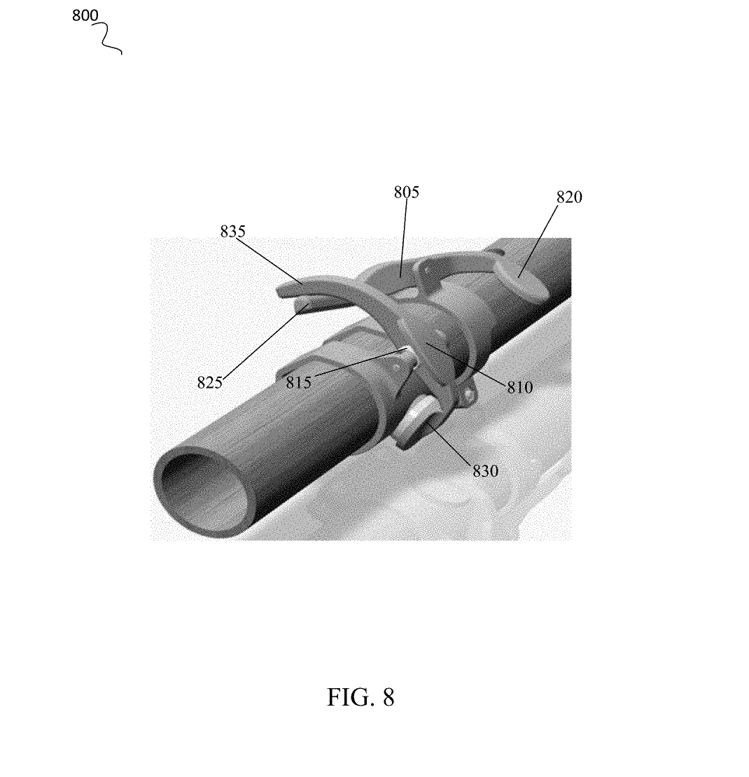

FIG. 8 illustrates an exemplary embodiment of a musical instrument assistance system 800 generally configured in an exemplary closed position, in accordance with an embodiment of the present invention, wherein, musical instrument assistance system 800 may be generally configured to be removably and adjustably joined to substantially any size woodwind musical instrument. In the present embodiment, musical instrument assistance system 800 may be configured to comprise at least, an exemplary, without limitation, trigger lever device 805, an exemplary, without limitation, valve lifter device 810, and an exemplary, without limitation, motion aiding device 815. Furthermore, in the present embodiment, trigger lever device 805 may be configured in an exemplary, without limitation, active position, wherein the active position may comprise an exemplary, without limitation, trigger lever device head portion 820, of the trigger lever device, configured in an exemplary, without limitation, depressed positon, and an exemplary, without limitation, trigger lever device contact end 825 configured in an exemplary, without limitation, raised position. Furthermore, in the present embodiment, valve lifter device 810, may be configured in an exemplary, without limitation closing position, wherein the closing position may comprise an exemplary, without limitation, valve lifter device cover portion 830, of the valve lifter device, configured in an exemplary, without limitation, cover positon, while generally, and simultaneously, an exemplary, without limitation, valve lifter device connection end 835 of the valve lever device, may be configured in an exemplary, without limitation, lifted position. Furthermore, in the present embodiment, motion aiding device 815, may be configured in an, exemplary, without limitation, energized position, wherein, the energized position may be configured by, for example, without limitation, compression. Moreover, the motion aiding device may comprise an exemplary, without limitation, potential energy. In the present embodiment, trigger lever device 805 may be configured in the active position by, for example, and not limitation, a user's finger, wherein a user may apply a suitable force to the trigger lever device head portion 820, such that the trigger lever head portion may be depressed. In the present embodiment, valve lifter device 810, may be configured in the closing position by, for example, without limitation, trigger lever device 805, wherein valve lifter device connection end 835 may be in general contact with the trigger lever device contact end 825, and the valve lifter device connection end may be configured in the lifted position, by the trigger lever device contact end, when the trigger lever device contact end may be configured in a raised position in response to the trigger lever device head portion being configured in the depressed position. In the present embodiment motion aiding device 815, may be configured in the energized position by, for example, and without limitation, valve lifter device 810 in conjunction with trigger lever device 805, wherein the energized position may further comprise the motion aiding device having an increased potential energy. The increased potential energy may be generally cause by for example, without limitation, trigger lever head portion 820 being configured in the depressed position, and essentially causing trigger lever connection end 825, to be configured in the raised position, and thus further essentially causing valve lifter device connection end 835, of the valve lifter device, to be configured in the lifted position, and thus essentially causing motion aiding device 815, to be generally configured and essentially compressed, wherein, compressing the motion aiding device may increase the potential energy of the motion aiding device, and thus may configure the motion aiding device to be in energized position/ In the present embodiment increasing the potential energy of motion aiding device 810, to an exemplary, without limitation, suitable amount may cause the valve lifter device cover portion 830 to be configured in the cover position, by an exemplary, without limitation, structural joining between, at least, motion aiding device 815, valve lifter device 810, and valve lifter device cover 830, wherein the cover position may comprise, without limitation, covering substantially any hole of a substantially any size woodwind musical instrument.

In an alternative embodiment, an exemplary, without limitation, trigger lever device may be configured in an active position by, for example, and not limitation, any finger of a user, another valve lifter device, substantially any user appendage, a strap or fastener, substantially any force producing object or action, and substantially any combination thereof. In an alternative embodiment, valve lifter device connection end may be configured in an exemplary, without limitation, lifted position by a user's finger or by a fixed position, such as, without limitation, generally fixing a valve lever device cover in an exemplary, without limitation, in an exemplary without, limitation, cover position. In an alternative embodiment an exemplary, without limitation, motion aiding device, may be configured in the energized position by, for example, and without limitation, another valve lifter device, a user, a fixed position of a valve lifter device, or any combination thereof. In another alternative embodiment, motion aiding device may comprise a spring of a particular stiffness so that compressing the spring and thus configuring the motion aiding device into an energized position may comprise a relatively high or relatively low suitable amount of potential energy increase, wherein the relatively high or relatively low suitable amount of energy increase may correspond to a relatively more difficult or relatively less difficult compression of the string respectively. In an alternative embodiment trigger lever device and/or valve lifter device may comprise a relatively heavy weight or relatively light weight material.

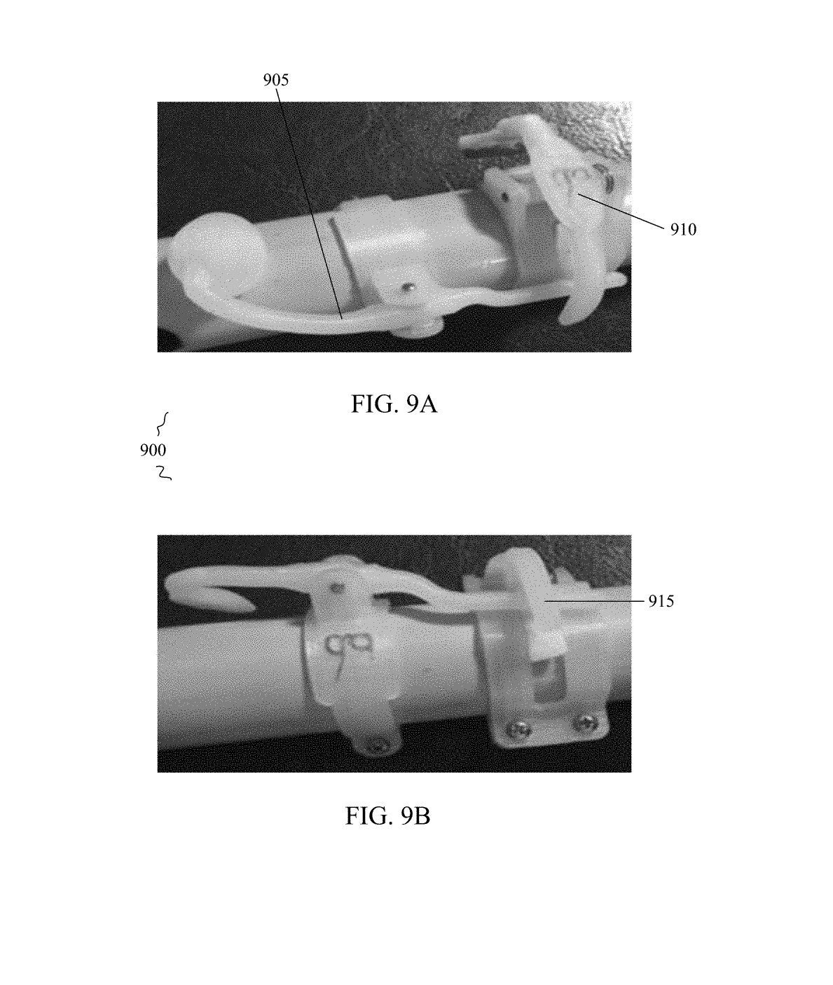

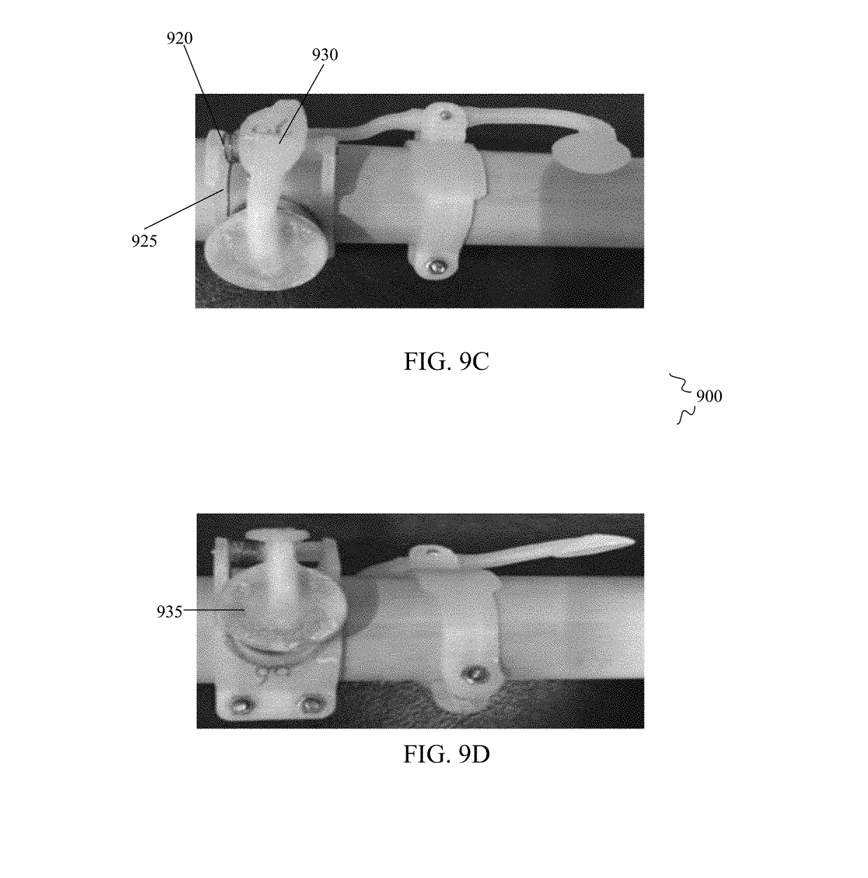

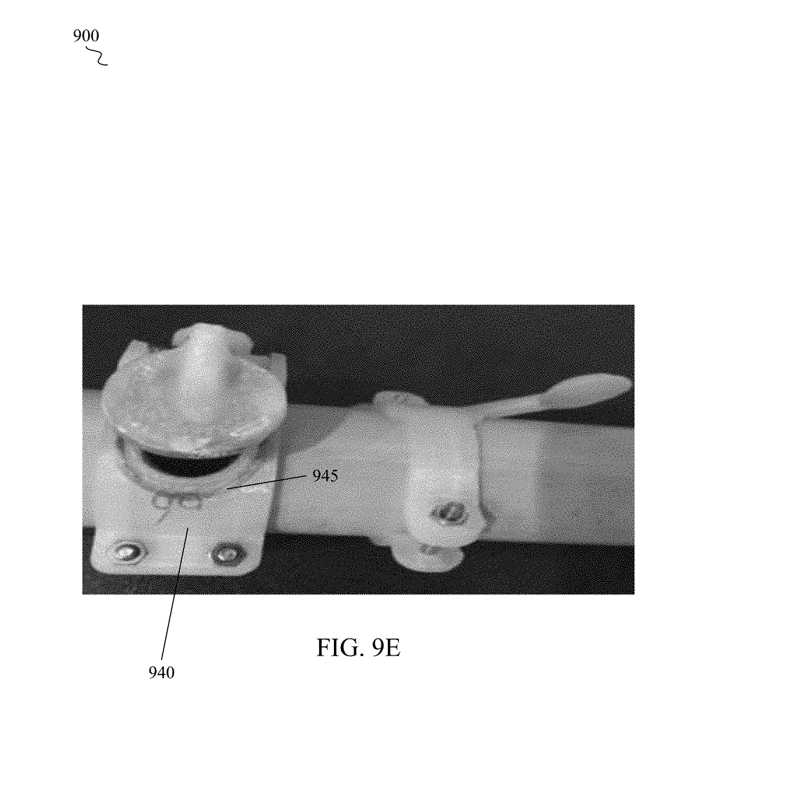

FIG. 9A through FIG. 9E illustrate various views of an exemplary configuration of an exemplary embodiment of a musical instrument assistance system, in accordance with an embodiment of the present invention, wherein FIG. 9A illustrates an exemplary rotated left perspective view thereof. Furthermore, in the present embodiment, FIG. 9A illustrates an exemplary, without limitation, configuration of an exemplary musical instrument assistance system 900, wherein the musical instrument assistance system may be configured in an exemplary, without limitation, open position. In the present embodiment, an exemplary, without limitation, trigger lever device 905, and an exemplary valve lifter device 910 are configured in resting positions respectively. Furthermore, FIG. 9B illustrates an exemplary rotated right perspective view thereof, wherein the trigger lever device and valve lifter device may be in general contact. In the present embodiment an exemplary valve lifter device end portion 915 may be curved to generally maintain the contact. FIG. 9C illustrates an exemplary further rotated left perspective view of the exemplary configuration of the exemplary embodiment of the musical instrument assistance system 900. In accordance with the present embodiment an exemplary, without limitation, motion aiding portion 920, may be configured in a relaxed positon, wherein motion aiding portion may be an exemplary, without limitation, coiled spring. Furthermore, the motion aiding portion may, for example, and without limitation, comprise, at least, a first motion aiding portion end and a second motion aiding portion end, wherein, the first motion aiding portion end may be generally joined to an exemplary, without limitation, portion of a strap 925, while the second motion aiding portion end may be generally joined to an exemplary, without limitation, valve lifter device 930. FIG. 9D illustrates an exemplary valve view of the exemplary configuration of the exemplary embodiment of a musical instrument assistance system 900, wherein, in accordance with the present invention, an exemplary, without limitation, valve lifter device cover 935, of the exemplary embodiment of a musical instrument assistance system 900, may be configured to be wider than a hole to be covered. and FIG. 9E illustrates an exemplary zoomed-in view thereof, the musical instrument assistance system, may comprise an exemplary, strap device 940, wherein, an exemplary, without limitation, insulation device may be installed on an inner surface the strap device 945. In the present embodiment, the insulation device may be, without limitation, an O-ring. Furthermore, the insulation device may be inserted between the strap and an exemplary, without limitation, any size woodwind musical instrument. In an alternative embodiment, an exemplary, without limitation, strap device and exemplary insulation device may be of a relatively large width. In many practical implementations, the Hole on the flute should be smaller than the hole opening in the Strap. The O Ring must be larger than the hole on the flute. This is required as it will change the frequency of the sound coming out of the hole and thus make the not off key.

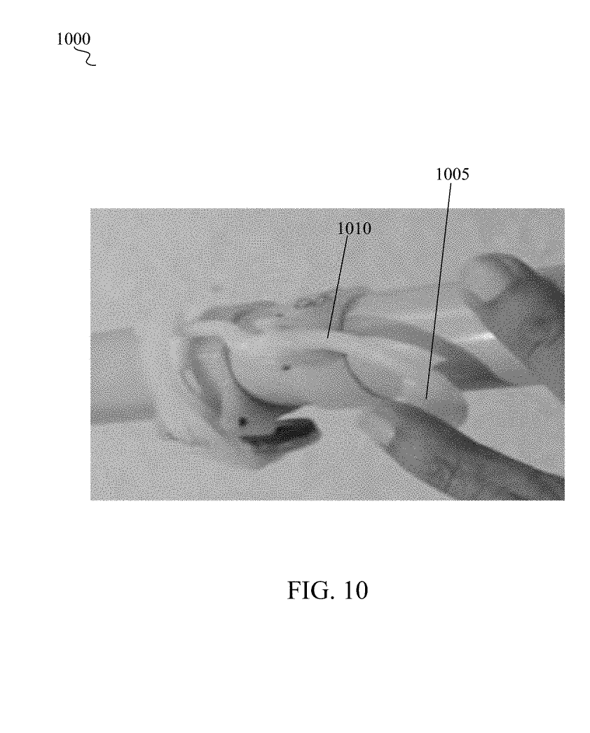

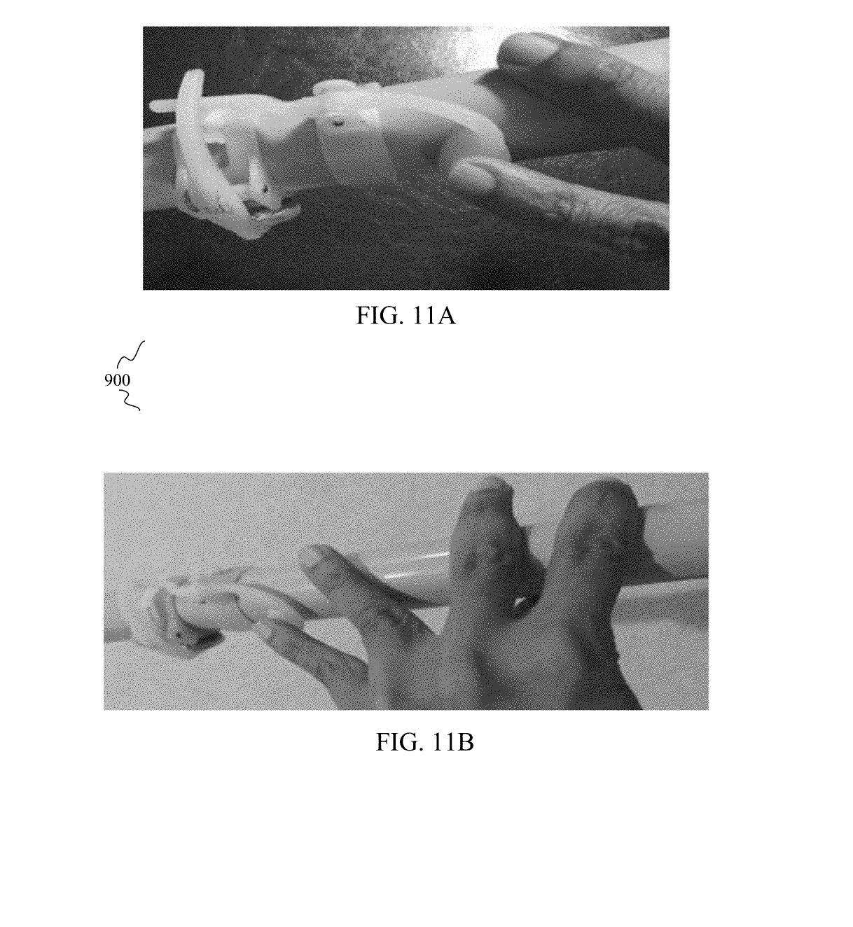

FIG. 10 illustrates an exemplary configuration of an exemplary embodiment of a musical instrument assistance system 1000, generally configured in an exemplary open position, in accordance with an embodiment of the present invention. In the present embodiment, an exemplary, without limitation, musical instrumentation assistance system 1000, may be generally fixed on an exemplary, without limitation, location of an exemplary, without limitation, woodwind musical instrument, wherein the location may be such that, without limitation, limitation, trigger lever device head portion 1005, of an exemplary, without limitation, trigger lever device 1010, may be in an exemplary, without limitation, close proximity to a user. Furthermore, the musical instrumentation assistance system, may comprise an exemplary, without limitation, ergonomically configured, trigger lever device 1005, wherein the trigger lever device may be ergonomically configured to be at least, easily accessible to an exemplary, without limitation, fifth digit of a user's left hand.

FIG. 11A and FIG. 11B illustrate various views of an exemplary configuration of an exemplary practical application of an embodiment of a musical instrument assistance system 1100, in accordance with an embodiment of the present invention, where FIG. 11A illustrates the exemplary embodiment of a musical instrument system generally configured in an exemplary closed position, and FIG. 11B illustrates a wide-range view thereof;

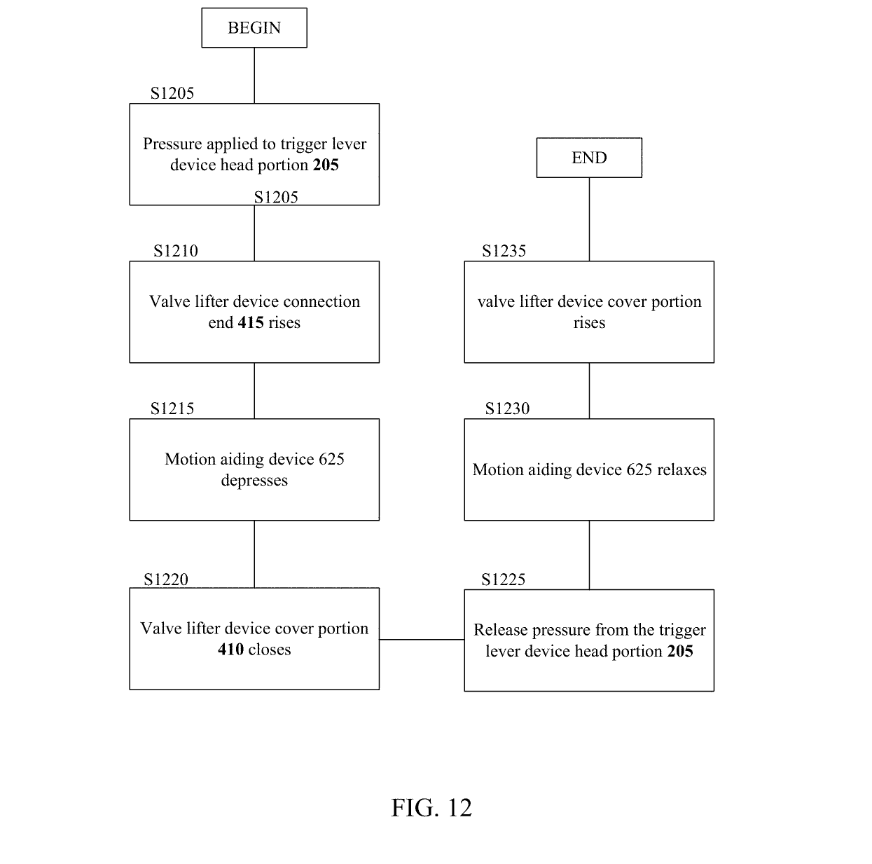

FIG. 12 illustrates a flow chart of an exemplary method of covering and opening a hole of a woodwind instrument in accordance with an embodiment of the present invention. In a step 1205, pressure is applied to a trigger lever device head portion 205, which results in a trigger lever contact end 220 rising. Contact between trigger lever contact end 220 and a valve lifter device connection end 415, causes the valve lifter device connection end 415 to rise in a step 1210. This causes a motion aiding device 625 to depress in a step 1215. In a step 1220 valve lifter device cover portion 410 then closes, covering a hole of a woodwind musical instrument. In a step 1225, pressure is released from the trigger lever device head portion 205. This causes the motion aiding device 625 to relax in a step 1230, and the valve lifter device cover portion rises in a step 1235, thus uncovering the hole of a woodwind musical instrument.

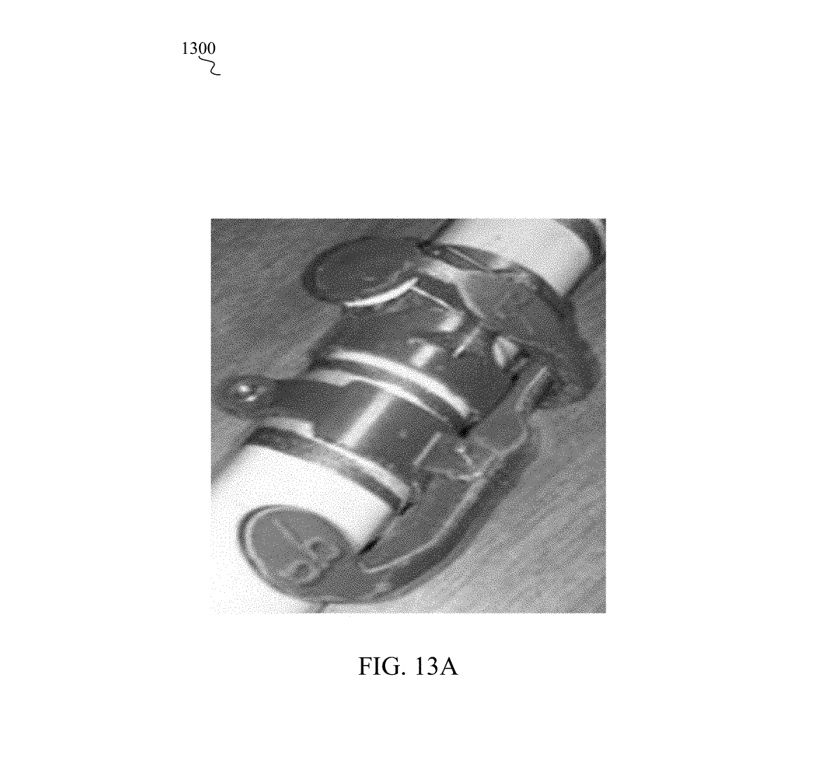

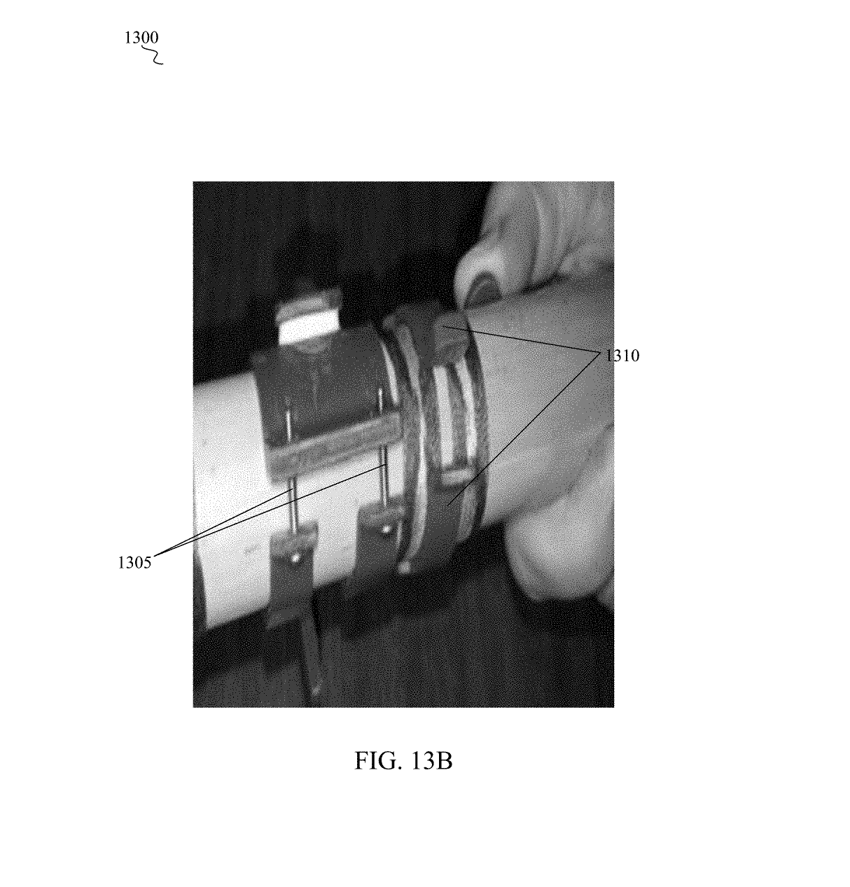

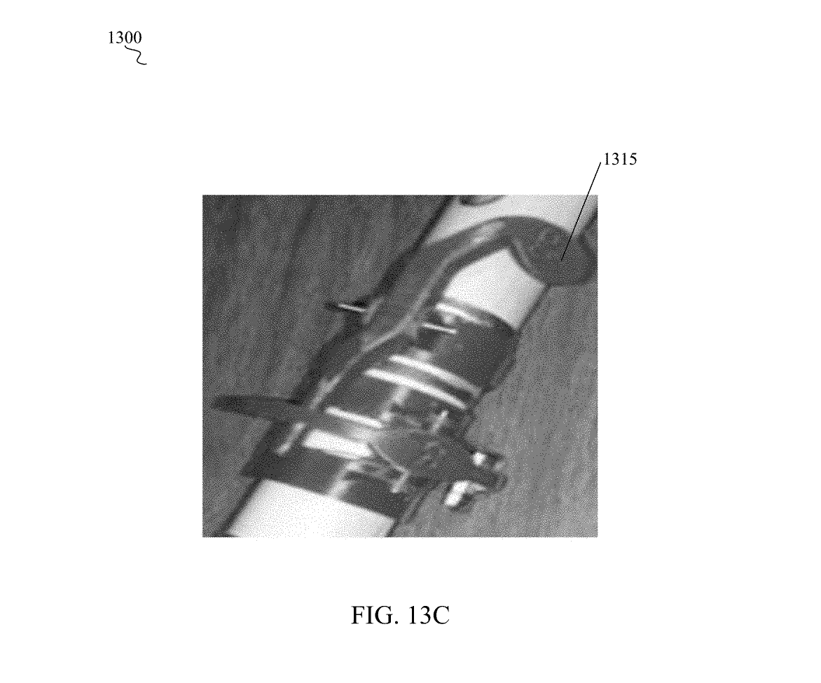

FIG. 13A through FIG. 13C illustrate an exemplary configuration of an exemplary embodiment of a musical instrument assistance system 1300, in accordance with an embodiment of the present invention. FIG. 13A illustrates a left perspective view of the exemplary configuration of the exemplary embodiment musical instrument assistance system, when the musical instrument assistance device may be colored. Furthermore, the system may be any desirable color. FIG. 13B illustrates a bottom perspective view thereof. Referring no to both FIG. 13B and FIG. 7A, it may be more readily apparent that in accordance with the embodiment of the present invention, musical instrument assistance system 1300, may be generally fixed to an exemplary, without limitation, woodwind instrument of relatively larger diameter, wherein a joining mechanism 1305, may comprise longer screws; furthermore, an exemplary, without limitation strap device 1310 may also be configured as a joining mechanism by generally being of an exemplary, without limitation, sufficient tensility and elasticity to generally be stretched and compressed onto the woodwind instrument. In the present embodiment a joining mechanism of the musical instrument assistance system 1000 may be comprised of and exemplary, without limitation, nut and screw mechanism, a sufficiently tensile and elastic strap body portion, or a combination thereof. Furthermore, a sufficiently tensile and elastic body strap portion may not need a nut and screw mechanism. In an alternative embodiment a joining mechanism may comprise at least one or any combination of, without limitation, a nut and screw mechanism, a sufficiently tensile and elastic strap body portion, or an adhesively lines body strap portion. FIG. 13C illustrates a top perspective view thereof wherein, an, exemplary, without limitation, trigger lever head portion 1315, may be configured to be an exemplary, without limitation, elongated circular shape. In an alternative embodiment, an exemplary, without limitation, trigger lever head portion may be any desired shape.

It is to be understood that any exact measurements/dimensions or particular construction materials indicated herein are solely provided as examples of suitable configurations and are not intended to be limiting in any way. Depending on the needs of the particular application, those skilled in the art will readily recognize, in light of the following teachings, a multiplicity of suitable alternative implementation details.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

It is noted that according to USA law 35 USC § 112 (1), all claims must be supported by sufficient disclosure in the present patent specification, and any material known to those skilled in the art need not be explicitly disclosed. However, 35 USC § 112 (6) requires that structures corresponding to functional limitations interpreted under 35 USC § 112 (6) must be explicitly disclosed in the patent specification. Moreover, the USPTO's Examination policy of initially treating and searching prior art under the broadest interpretation of a “mean for” claim limitation implies that the broadest initial search on 112(6) functional limitation would have to be conducted to support a legally valid Examination on that USPTO policy for broadest interpretation of “mean for” claims. Accordingly, the USPTO will have discovered a multiplicity of prior art documents including disclosure of specific structures and elements which are suitable to act as corresponding structures to satisfy all functional limitations in the below claims that are interpreted under 35 USC § 112 (6) when such corresponding structures are not explicitly disclosed in the foregoing patent specification. Therefore, for any invention element(s)/structure(s) corresponding to functional claim limitation(s), in the below claims interpreted under 35 USC § 112 (6), which is/are not explicitly disclosed in the foregoing patent specification, yet do exist in the patent and/or non-patent documents found during the course of USPTO searching, Applicant(s) incorporate all such functionally corresponding structures and related enabling material herein by reference for the purpose of providing explicit structures that implement the functional means claimed. Applicant(s) request(s) that fact finders during any claims construction proceedings and/or examination of patent allowability properly identify and incorporate only the portions of each of these documents discovered during the broadest interpretation search of 35 USC § 112 (6) limitation, which exist in at least one of the patent and/or non-patent documents found during the course of normal USPTO searching and or supplied to the USPTO during prosecution. Applicant(s) also incorporate by reference the bibliographic citation information to identify all such documents comprising functionally corresponding structures and related enabling material as listed in any PTO Form-892 or likewise any information disclosure statements (IDS) entered into the present patent application by the USPTO or Applicant(s) or any 3^{rd} parties. Applicant(s) also reserve its right to later amend the present application to explicitly include citations to such documents and/or explicitly include the functionally corresponding structures which were incorporate by reference above.

Thus, for any invention element(s)/structure(s) corresponding to functional claim limitation(s), in the below claims, that are interpreted under 35 USC § 112 (6), which is/are not explicitly disclosed in the foregoing patent specification, Applicant(s) have explicitly prescribed which documents and material to include the otherwise missing disclosure, and have prescribed exactly which portions of such patent and/or non-patent documents should be incorporated by such reference for the purpose of satisfying the disclosure requirements of 35 USC § 112 (6). Applicant(s) note that all the identified documents above which are incorporated by reference to satisfy 35 USC § 112 (6) necessarily have a filing and/or publication date prior to that of the instant application, and thus are valid prior documents to incorporated by reference in the instant application.

Having fully described at least one embodiment of the present invention, other equivalent or alternative methods of implementing a musical instrument assistance system, more particularly, devices which may be joined to musical instruments, to allow particular sounds to be played according to the present invention will be apparent to those skilled in the art. Various aspects of the invention have been described above by way of illustration, and the specific embodiments disclosed are not intended to limit the invention to the particular forms disclosed. The particular implementation of the musical instrument assistance system, more particularly, devices which may be joined to musical instruments, to allow particular sounds to be played may vary depending upon the particular context or application. By way of example, and not limitation, the musical instrument assistance system, more particularly, devices which may be joined to musical instruments, to allow particular sounds to be played, described in the foregoing were principally directed to a system of adjustable devices to allow a user to cover any size open hole of any size woodwind musical instrument implementations; however, similar techniques may instead be applied to assistance devices for playing any instrument where a users' fingers must be able to reach and apply pressure in particular places, for example string instruments, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

The corresponding structures, materials, acts, and equivalents of all means or step plus function elements in the claims below are intended to include any structure, material, or act for performing the function in combination with other claimed elements as specifically claimed.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The Abstract is provided to comply with 37 C.F.R. Section 1.72(b) requiring an abstract that will allow the reader to ascertain the nature and gist of the technical disclosure. That is, the Abstract is provided merely to introduce certain concepts and not to identify any key or essential features of the claimed subject matter. It is submitted with the understanding that it will not be used to limit or interpret the scope or meaning of the claims.

The following claims are hereby incorporated into the detailed description, with each claim standing on its own as a separate embodiment.

1. An apparatus for attaching to a musical instrument in order to allow particular sounds to be played comprising:
means for a floating Key system that allows any size hole, placed anywhere on any woodwind device to be closed and opened by an available free finger or in conjunction with another lever system;
means for making said floating Key system means a removable device such that it does not interfere with the original design of the instrument; and
means for enabling more than one of said floating Key system means to be used in conjunction with each other.
